(19) United States
(12) Patent Application Publication
(10) Pub. No.: US 2025/0167630 A1
(43) Pub. Date: May 22, 2025

(54) POWER TOOL AND BATTERY PACK THEREOF

(71) Applicant: Nanjing Chervon Industry Co., Ltd., Nanjing (CN)

(72) Inventors: Xiaohong Lin, Nanjing (CN); Jing Li, Nanjing (CN); Rong Fan, Nanjing (CN); Xue Hu, Nanjing (CN)

(21) Appl. No.: 18/926,661

(22) Filed: Oct. 25, 2024

(30) Foreign Application Priority Data
Nov. 22, 2023 (CN) 202311573032.6

(51) Int. Cl. H02K 7/14; H01M 50/211; H01M 50/247; H01M 50/51

(52) U.S. Cl. CPC H02K 7/145; H01M 50/211; H01M 50/247; H01M 50/51; H01M 2220/30

(57) ABSTRACT

A power tool includes a tool body including an output piece, an electric motor for driving the output piece, and a body housing for accommodating the electric motor; and a battery pack detachably connected to the body housing to supply power to the electric motor. The tool body includes a body interface, the battery pack includes a battery pack interface mating with the body interface, and when the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell and the battery pack has a volumetric energy density greater than or equal to 100 mWh/cm³ and a nominal voltage less than or equal to 9 V.

This application claims the benefit under 35 U.S.C. § 119(a) of Chinese Patent Application No. 202311573032.6, filed on Nov. 22, 2023, which application is incorporated herein by reference in its entirety.

### TECHNICAL FIELD

The present application relates to the field of tools and, in particular, to a power tool, a battery pack, and a charging combination.

### BACKGROUND

A power tool in the related art usually includes a tool body and a battery pack. Existing tool bodies usually include power tools with a high voltage platform and power tools with a low voltage platform. Battery packs in the power tools with the low voltage platform have a relatively low energy density, resulting in a relatively short battery life of the power tools.

This part provides background information related to the present application, and the background information is not necessarily the existing art.

### SUMMARY

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell and the battery pack has a nominal voltage greater than or equal to 3 V and less than or equal to 9 V.

In an example, the battery pack has a nominal voltage greater than or equal to 7 V and less than or equal to 9 V.

In an example, the number of cell units is less than or equal to 4.

In an example, multiple cell units are disposed in the battery pack housing, and the multiple cell units are stacked.

In an example, the body housing includes a grip. When the battery pack is coupled to the tool body, part of the battery pack housing is located in the grip.

In an example, the body housing includes a grip. When the battery pack is coupled to the tool body, part of the cell unit is located in the grip.

In an example, the battery pack has a nominal voltage less than or equal to 13 V.

A charging combination includes a charger and a battery pack, where the charger is configured to charge the battery pack. The charger includes a charger housing formed with a charging coupling portion for detachably coupling the battery pack; and a charging interface electrically connected to the battery pack to transmit power to the battery pack and charge the battery pack. The battery pack includes a battery pack housing; a cell unit disposed in the battery pack housing; and a battery pack interface connected to the charging interface when the battery pack is coupled to the charger. The battery pack interface is electrically connected to the cell unit, the cell unit is a pouch cell, and the battery pack has a nominal voltage less than or equal to 9 V.

A battery pack applicable to a power tool includes a battery pack housing; a cell unit disposed in the battery pack housing; and a battery pack interface for outputting power to the power tool, where the battery pack interface is electrically connected to the cell unit. The battery pack is configured to be detachably connected to the power tool, the number of cell units is less than or equal to 4, the cell unit is a pouch cell, and the battery pack has a nominal voltage less than or equal to 9 V.

In an example, the battery pack interface includes a positive terminal, a negative terminal, and a terminal circuit board. The positive terminal and the negative terminal are mounted to the terminal circuit board. The positive terminal and the negative terminal are connected to the cell unit. At least part of multiple cell units are stacked along a stacking direction. The terminal circuit board is disposed at an end of multiple cell units stacked along the stacking direction.

A power tool includes a tool body including an output piece for outputting power, an electric motor for driving the output piece to move, and a body housing for accommodating at least part of the electric motor; and a battery pack for supplying power to the electric motor. The battery pack further includes at least one cell unit configured to store electrical energy. Each of the at least one cell unit is a pouch cell, and the battery pack has a nominal voltage greater than or equal to 3 V and less than or equal to 9 V.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell and the output power of the battery pack is greater than or equal to 140 W and less than or equal to 750 W.

In an example, the battery pack has a nominal voltage less than or equal to 9 V.

In an example, the number of cell units is less than or equal to 4, and at least part of multiple cell units are stacked.

In an example, the body housing includes a grip for a user to hold. When the battery pack is coupled to the tool body, part of the battery pack housing is located in the grip.

In an example, the body housing includes a grip for a user to hold. When the battery pack is coupled to the tool body, part of the cell unit is located in the grip.

In an example, the body housing includes an electric motor accommodation portion for accommodating the electric motor and a grip for a user to hold, an extension direction of the electric motor accommodation portion intersects an extension direction of the grip, and the battery pack is coupled to the grip along the extension direction of the grip.

In an example, the power tool is a screwdriver, an electric drill, an impact drill, a sander, or a cutter.

In an example, the body housing includes an electric motor accommodation portion for accommodating the electric motor and a grip for a user to hold, an extension direction of the electric motor accommodation portion is basically the same as an extension direction of the grip, and the battery pack is coupled to the grip along the extension direction of the grip.

In an example, when the battery pack is coupled to the tool body, the power tool is basically linear.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and at least one cell unit configured to store electrical energy, disposed in the battery pack housing, and electrically connected to the battery pack interface. The body housing includes an electric motor accommodation portion for accommodating the electric motor and a grip for a user to hold, an extension direction of the electric motor accommodation portion is basically the same as an extension direction of the grip, and the battery pack is coupled to the grip along the extension direction of the grip. Each of the at least one cell unit is a pouch cell, and the output power of the battery pack is greater than or equal to 140 W and less than or equal to 750 W.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell and the battery pack has a volumetric energy density greater than or equal to 100 mWh/cm³ and a nominal voltage less than or equal to 9 V.

In an example, the battery pack has a volumetric energy density greater than or equal to 120 mWh/cm³.

In an example, the battery pack has a gravimetric energy density greater than or equal to 100 mWh/g.

In an example, the battery pack has a nominal voltage of 8 V.

In an example, two cell units are disposed in the battery pack housing, and the battery pack has a weight less than or equal to 200 g.

In an example, two cell units are disposed in the battery pack housing, and the battery pack has a volume less than or equal to 200 cm³.

In an example, the battery pack has a capacity greater than or equal to 1.5 Ah and less than or equal to 5 Ah.

In an example, four cell units are disposed in the battery pack housing, and the four cell units constitute a 2P cell group.

In an example, the body housing includes an electric motor accommodation portion for accommodating the electric motor and a grip for a user to hold. When the battery pack is coupled to the tool body, at least part of the cell unit is located in the grip.

A battery pack applicable to a power tool includes a battery pack housing formed with a coupling portion for connecting the power tool; a cell unit disposed in the battery pack housing; and a battery pack interface used for outputting power to the power tool and electrically connected to the cell unit. The cell unit is a pouch cell and the battery pack has a volumetric energy density greater than or equal to 100 mWh/cm³ and a nominal voltage less than or equal to 9 V.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell and the battery pack has a gravimetric energy density greater than or equal to 100 mWh/g and a nominal voltage less than or equal to 9 V.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The ratio of the output power of the battery pack to the volume of the battery pack is greater than or equal to 1 W/cm³, and the volume of the battery pack is less than or equal to 150 cm³.

In an example, two cell units are disposed in the battery pack housing, and the two cell units are connected in series.

In an example, the output power of the battery pack is greater than or equal to 140 W and less than or equal to 750 W.

In an example, the battery pack has a gravimetric energy density greater than or equal to 100 mWh/g.

In an example, two cell units are disposed in the battery pack housing, and the battery pack has a weight less than or equal to 180 g.

In an example, the battery pack has a capacity greater than or equal to 1.5 Ah and less than or equal to 5 Ah.

In an example, the power tool is a handheld power tool, the body housing includes a grip for a user to hold, and the battery pack is coupled to the grip.

A battery pack applicable to a power tool includes a battery pack housing; a cell unit disposed in the battery pack housing; and a battery pack interface for outputting power to the power tool, where the battery pack interface is electrically connected to the cell unit. The battery pack is configured to be detachably coupled to the power tool, and the battery pack has a volumetric energy density greater than or equal to 100 mWh/cm³ and a volume less than or equal to 250 cm³.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The ratio of the output power of the battery pack to the volume of the battery pack is greater than or equal to 1 W/cm³, and the volume of the battery pack is less than or equal to 150 cm³.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The cell unit is a pouch cell. The ratio of the output power of the battery pack to the weight of the battery pack is greater than or equal to 1 W/g, and the weight of the battery pack is less than or equal to 180 g.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. The cell unit is a pouch cell. When the battery pack is coupled to the tool body, at least part of the cell unit is located in the grip, the battery pack is coupled to the grip along a direction of a first straight line, the perimeter of an outer contour of a cross-section of a portion of the battery pack in the grip in a plane perpendicular to the first straight line is greater than or equal to 10 cm and less than or equal to 14 cm, and the ratio of the output power of the battery pack to the volume of the battery pack is greater than or equal to 1 W/cm³.

In an example, the battery pack has a nominal voltage greater than or equal to 7 V.

In an example, the number of cell units in the battery pack housing is greater than or equal to 2.

In an example, an extension plane of the pouch cell is basically parallel to the first straight line.

In an example, two cell units are disposed in the battery pack housing, and the battery pack has a capacity greater than or equal to 1.5 Ah and less than or equal to 5 Ah.

In an example, the battery pack has a volumetric energy density greater than or equal to 120 mWh/cm³.

In an example, the perimeter of an outer contour of a cross-section of the grip in the plane perpendicular to the first straight line is greater than or equal to 12.5 cm and less than or equal to 16 cm.

In an example, the battery pack has a gravimetric energy density greater than or equal to 110 mWh/g.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. The cell unit is a pouch cell. When the battery pack is coupled to the tool body, at least part of the cell unit is located in the grip, the battery pack is coupled to the grip along a direction of a first straight line, the perimeter of an outer contour of a cross-section of a portion of the battery pack in the grip in a plane perpendicular to the first straight line is greater than or equal to 10 cm and less than or equal to 14 cm, and the battery pack has a volumetric energy density greater than or equal to 100 mWh/cm³.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. When the battery pack is coupled to the tool body, at least part of the cell unit is located in the grip, the battery pack is coupled to the grip along a direction of a first straight line, the perimeter of an outer contour of a cross-section of a portion of the battery pack in the grip in a plane perpendicular to the first straight line is greater than or equal to 10 cm and less than or equal to 14 cm, and the battery pack has a gravimetric energy density greater than or equal to 100 mWh/g.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. The cell unit is a pouch cell. When the battery pack is coupled to the tool body, at least part of the cell unit is located in the grip, the battery pack is coupled to the grip along a direction of a first straight line, the area of a cross-section of a portion of the battery pack in the grip in a plane perpendicular to the first straight line is greater than or equal to 8 cm² and less than or equal to 14 cm², and the ratio of the output power of the battery pack to the volume of the battery pack is greater than or equal to 1 W/cm³.

In an example, the battery pack has a nominal voltage greater than or equal to 7 V.

In an example, the number of cell units in the battery pack housing is greater than or equal to 2.

In an example, an extension plane of the pouch cell is basically parallel to the first straight line.

In an example, two cell units are disposed in the battery pack housing, and the battery pack has a capacity greater than or equal to 1.5 Ah and less than or equal to 5 Ah.

In an example, the battery pack has a volumetric energy density greater than or equal to 120 mWh/cm³.

In an example, the area of a cross-section of the grip in the plane perpendicular to the first straight line is greater than or equal to 13 cm² and less than or equal to 18 cm².

In an example, the battery pack has a gravimetric energy density greater than or equal to 110 mWh/g.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. The cell unit is a pouch cell. When the battery pack is coupled to the tool body, at least part of the cell unit is located in the grip, the battery pack is coupled to the grip along a direction of a first straight line, the area of a cross-section of a portion of the battery pack in the grip in a plane perpendicular to the first straight line is greater than or equal to 8 cm² and less than or equal to 14 cm², and the battery pack has a volumetric energy density greater than or equal to 100 mWh/cm³.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. When the battery pack is coupled to the tool body, at least part of the cell unit is located in the grip, the battery pack is coupled to the grip along a direction of a first straight line, the area of a cross-section of a portion of the battery pack in the grip in a plane perpendicular to the first straight line is greater than or equal to 8 cm² and less than or equal to 14 cm², and the battery pack has a gravimetric energy density greater than or equal to 100 mWh/g.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. When the battery pack is coupled to the tool body, at least part of the cell unit is located in the grip, the battery pack is coupled to the grip along a direction of a first straight line, and the area of a cross-section of a portion of the battery pack in the grip in a plane perpendicular to the first straight line is greater than or equal to 8 cm² and less than or equal to 14 cm². The cell unit is a pouch cell.

In an example, the battery pack has a nominal voltage greater than or equal to 7 V.

In an example, the number of cell units in the battery pack housing is greater than or equal to 2.

In an example, the battery pack has a nominal voltage less than or equal to 9 V.

In an example, an extension plane of the cell unit in the grip is basically parallel to the direction of the first straight line.

In an example, the area of a cross-section of the grip in the plane perpendicular to the first straight line is greater than or equal to 13 cm² and less than or equal to 18 cm².

In an example, a dimension of the cross-section in a width direction perpendicular to the first straight line is greater than or equal to 3.7 cm and less than or equal to 4.7 cm.

In an example, a dimension of the cross-section in a thickness direction perpendicular to the first straight line and the width direction is greater than or equal to 2.7 cm and less than or equal to 3.7 cm.

In an example, two cell units are disposed in the battery pack housing, and the energy of the battery pack is greater than or equal to 7 Wh and less than or equal to 9 Wh.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. When the battery pack is coupled to the tool body, at least part of the cell unit is located in the grip, the battery pack is coupled to the grip along a direction of a first straight line, the width of a cross-section of a portion of the battery pack in the grip in a plane perpendicular to the first straight line is greater than or equal to 3.7 cm and less than or equal to 4.7 cm, and the thickness of the cross-section is greater than or equal to 2.7 cm and less than or equal to 3.7 cm. The cell unit is a pouch cell.

A power tool includes a tool body including an output piece for outputting power, an electric motor for driving the output piece to move, and a body housing for accommodating at least part of the electric motor; and a battery pack for supplying power to the electric motor. The battery pack further includes at least one cell unit configured to store energy. The body housing includes an electric motor housing portion for accommodating at least part of the electric motor; and a grip for a user to hold. At least part of the at least one cell unit is located in the grip, the grip extends along a direction of a first straight line, an extension plane of a cell unit is parallel to the first straight line, the area of a cross-section of the grip in a plane perpendicular to the first straight line is greater than or equal to 13 cm² and less than or equal to 18 cm², and each of the at least one cell unit is a pouch cell.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold. When the battery pack is coupled to the tool body, at least part of the cell unit is located in the grip, the battery pack is coupled to the grip along a direction of a first straight line, and the perimeter of an outer contour of a cross-section of a portion of the battery pack in the grip in a plane perpendicular to the first straight line is greater than or equal to 10 cm and less than or equal to 14 cm. The cell unit is a pouch cell.

In an example, the battery pack has a nominal voltage greater than or equal to 7 V.

In an example, the number of cell units in the battery pack housing is greater than or equal to 2.

In an example, the battery pack has a nominal voltage less than or equal to 9 V.

In an example, an extension plane of the cell unit in the grip is basically parallel to the direction of the first straight line.

In an example, the perimeter of an outer contour of a cross-section of the grip in the plane perpendicular to the first straight line is greater than or equal to 12.5 cm and less than or equal to 16 cm.

In an example, a dimension of the cross-section in a width direction perpendicular to the first straight line is greater than or equal to 3.7 cm and less than or equal to 4.7 cm.

In an example, a dimension of the cross-section in a thickness direction perpendicular to the first straight line and the width direction is greater than or equal to 2.7 cm and less than or equal to 3.7 cm.

In an example, two cell units are disposed in the battery pack housing, and the energy of the battery pack is greater than or equal to 7 Wh and less than or equal to 9 Wh.

In an example, cell units include a first group of cells and a second group of cells. When the battery pack is coupled to the tool body, the first group of cells is at least partially disposed in the grip, and the second group of cells is located outside the grip.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; and a cell unit disposed in the battery pack housing and electrically connected to the battery pack interface. The body housing includes an electric motor housing portion for accommodating at least part of the electric motor; and a grip for a user to hold and extending basically along a direction of a first straight line. The cell unit is a pouch cell. When the battery pack is coupled to the tool body, at least part of the cell unit is located in the grip, and an extension plane of the cell unit at least partially located in the grip is basically parallel to the first straight line. The battery pack has a nominal voltage greater than or equal to 7 V and less than or equal to 9 V.

In an example, the battery pack further includes a power management board, where an extension plane of the power management board is basically parallel to the extension plane of the cell unit at least partially located in the grip.

In an example, the battery pack further includes a power management board, where the power management board is stacked on a side surface of the cell unit at least partially located in the grip.

In an example, cell units at least partially located in the grip are defined as a first group of cells. Along the direction of the first straight line, the first group of cells includes a first end facing the body interface and a second end opposite to the first end. The battery pack interface is disposed at the first end.

In an example, the battery pack interface includes at least one terminal of the battery pack. The battery pack further includes a terminal circuit board for mounting the at least one terminal of the battery pack, and the terminal circuit board is disposed at the first end.

In an example, the terminal circuit board extends basically along a direction perpendicular to the first straight line.

In an example, two cell units are at least partially located in the grip.

In an example, cell units at least partially located in the grip are defined as a first group of cells. The battery pack further includes a second cell unit located outside the grip when the battery pack is coupled to the tool body. The second cell unit is a pouch cell, and an extension plane of the second cell unit is basically perpendicular to the extension plane of the cell unit.

In an example, cell units at least partially located in the grip are defined as a first group of cells. The battery pack further includes multiple second cell units located outside the grip when the battery pack is coupled to the tool body. The multiple second cell units are each a pouch cell, the cell units in the first group of cells are connected in series, and the multiple second cell units are connected in series.

A power tool includes a tool body including an output piece for outputting power, an electric motor for driving the output piece to move, and a body housing for accommodating at least part of the electric motor; and a battery pack for supplying power to the electric motor. The battery pack further includes at least one cell unit configured to store energy. The body housing includes an electric motor housing portion for accommodating at least part of the electric motor; and a grip for a user to hold and extending basically along a direction of a first straight line. Each of the at least one cell unit is a pouch cell, at least part of the at least one cell unit is located in the grip, and an extension plane of a cell unit at least partially located in the grip is basically parallel to the first straight line.

A battery pack applicable to a power tool includes a battery pack housing formed with a coupling portion for connecting the power tool; a cell unit disposed in the battery pack housing, where the cell unit is a pouch cell and extends basically in a first plane; a battery pack interface used for outputting power to the power tool and electrically connected to the cell unit; and a power management board, where an extension plane of the power management board is basically parallel to the first plane so that the power management board is disposed on a side surface of the cell unit. The coupling portion is configured to make the battery pack detachably connected to the power tool. The battery pack interface includes at least one terminal of the battery pack, where the at least one terminal of the battery pack is located at an end of the cell unit.

In an example, the battery pack is configured to be coupled to the power tool along a direction of a first straight line, and the direction of the first straight line is basically parallel to the first plane.

In an example, the cell unit is basically rectangular, and the at least one terminal of the battery pack is located at an end of long sides of a rectangle.

In an example, the cell unit is basically rectangular, the length of the cell unit is greater than or equal to 5.7 cm and less than or equal to 6.7 cm, and the width of the cell unit is greater than or equal to 2.7 cm and less than or equal to 3.7 cm.

In an example, the battery pack has a nominal voltage greater than or equal to 7 V and less than or equal to 9 V.

In an example, the battery pack further includes a terminal circuit board for mounting the at least one terminal of the battery pack, and the terminal circuit board is disposed at an end of the cell unit.

In an example, the terminal circuit board and the power management board are disposed separately.

A battery pack applicable to a power tool includes a battery pack housing formed with a coupling portion for connecting the power tool; a cell unit disposed in the battery pack housing, where the cell unit is a pouch cell and extends basically in a first plane; a battery pack interface used for outputting power to the power tool, electrically connected to the cell unit, and including at least one terminal of the battery pack; a power management board, where an extension plane of the power management board is basically parallel to the first plane so that the power management board is disposed on a side surface of the cell unit; and a terminal circuit board for supporting the at least one terminal of the battery pack. The coupling portion is configured to make the battery pack detachably connected to the power tool. The terminal circuit board and the power management board are disposed separately. An extension plane of the terminal circuit board is not parallel to the extension plane of the power management board.

In an example, the battery pack has a nominal voltage greater than or equal to 7 V and less than or equal to 9 V.

In an example, the extension plane of the terminal circuit board is perpendicular to the extension plane of the power management board.

In an example, the cell unit is basically rectangular, the length of the cell unit is greater than or equal to 5.7 cm and less than or equal to 6.7 cm, and the width of the cell unit is greater than or equal to 2.7 cm and less than or equal to 3.7 cm.

In an example, two cell units are disposed parallel to the power management board.

A battery pack applicable to a power tool includes a battery pack housing formed with a coupling portion for connecting the power tool; a cell unit disposed in the battery pack housing, where the cell unit is a pouch cell and extends basically in a first plane; a battery pack interface used for outputting power to the power tool, electrically connected to the cell unit, and including at least one terminal of the battery pack; a power management board, where an extension plane of the power management board is basically parallel to the first plane so that the power management board is disposed on a side surface of the cell unit; and an element mounted on a side of the power management board facing away from the cell unit. The volume of the element is greater than or equal to 100 m³, and the element is disposed on a central axis of the power management board in a length direction or a width direction.

In an example, the battery pack has a nominal voltage greater than or equal to 7 V and less than or equal to 9 V.

In an example, the number of cell units parallel to the power management board in the battery pack housing is less than or equal to 2.

A charging combination includes a first charger and a battery pack, where the first charger is configured to charge the battery pack; and the battery pack includes a battery pack housing; a cell unit disposed in the battery pack housing; and a first interface configured to connect the first charger to access power. The first charger includes a first charging interface detachably connected to the first interface, the cell unit is a pouch cell, and the first interface is a Type-C interface.

In an example, the battery pack further includes a battery pack interface for connecting the power tool so that the battery pack supplies power to the power tool, and the battery pack interface includes a terminal of the battery pack.

In an example, the charging combination further includes a second charger, and the second charger includes a second charging interface connected to the battery pack interface to charge the battery pack.

In an example, the charging combination further includes a controller configured to prevent the battery pack interface from access to power when the first charger is connected to the battery pack.

In an example, the charging combination further includes a controller configured to prevent the first interface from access to power when the second charger is connected to the battery pack.

In an example, the charging power with which the second charger charges the cell unit through the first interface is greater than or equal to 30 W.

In an example, the charging power with which the first charger charges the cell unit through the battery pack interface is less than or equal to 15 W.

In an example, the charging power with which the first charger charges the cell unit through the first interface is greater than or equal to 15 W.

In an example, the charging power with which the first charger charges the cell unit through the first interface is greater than or equal to 18 W.

In an example, the battery pack has a nominal voltage greater than or equal to 7 V and less than or equal to 9 V.

A charging combination includes a first charger and a power tool. The power tool includes a tool body including a body housing and an electric motor accommodated in the body housing; and a battery pack configured to supply power to the electric motor. The first charger is configured to charge the battery pack. The battery pack includes at least one cell unit configured to store energy. The battery pack is detachably coupled to the tool body, or the battery pack is built into the body housing. The first charger includes a first charging interface electrically connected to the battery pack to charge the battery pack, each of the at least one cell unit is a pouch cell, and the first charging interface is a Type-C interface.

In an example, the battery pack is detachably coupled to the tool body, and the battery pack includes a first interface mating with the first charging interface. When the battery pack is mounted to the tool body, the first interface is configured to allow the first charger to charge the battery pack.

A power tool includes a tool body including an output piece for outputting power, an electric motor for driving the output piece to move, and a body housing for accommodating at least part of the electric motor; and a battery pack detachably connected to the body housing to supply power to the electric motor. The tool body includes a body interface, and the battery pack includes a battery pack interface mating with the body interface. When the battery pack is mounted to the tool body, the body interface is connected to the battery pack interface. The battery pack further includes a battery pack housing; a cell unit disposed in the battery pack housing and electrically connected to the battery pack interface; and a first interface disposed on the battery pack housing to charge the battery pack. The cell unit is a pouch cell. When the battery pack is coupled to the tool body, at least part of the cell unit is located in the body housing, and the first interface is located outside the body housing. The first interface is a Type-C interface.

In an example, when the battery pack is mounted to the tool body, the first interface is configured to allow access to electrical energy to charge the battery pack.

In an example, the body housing includes a grip for a user to hold. When the battery pack is combined with the tool body, at least part of the cell unit is located in the grip and the first interface is located outside the grip.

In an example, the grip extends along a direction of a first straight line, and the battery pack is coupled to the grip along the direction of the first straight line.

In an example, when the battery pack is mounted to the tool body and the power tool is in operation, the first interface is configured to allow access to electrical energy to charge the battery pack.

A battery pack applicable to a power tool includes a battery pack housing formed with a coupling portion for connecting the power tool; a cell unit disposed in the battery pack housing; a power management board disposed in the battery pack housing; a battery pack interface connected to the power tool to supply power to the power tool; and a wireless charging device configured to mate with a wireless charging apparatus to charge the cell unit. The cell unit is a pouch cell, and the wireless charging device is connected to the power management board.

In an example, the maximum charging power of the wireless charging device is less than or equal to 15 W.

In an example, the maximum charging power of the wireless charging device is greater than 15 W.

In an example, multiple cell units are included, the multiple cell units are stacked, and the wireless charging device includes a receiving coil, where the receiving coil is at least partially disposed at an end of the multiple cell units stacked.

In an example, the battery pack interface is disposed at the other end of the multiple cell units stacked.

A charging combination includes a battery pack and a wireless charging apparatus configured to charge the battery pack. The battery pack includes a battery pack housing; a cell unit disposed in the battery pack housing; a power management board disposed in the battery pack housing; a battery pack interface configured to be connected to a power tool to supply power to the power tool; and a wireless charging device configured to mate with the wireless charging apparatus to charge the cell unit. The battery pack is detachably coupled to the power tool to supply power to the power tool, the cell unit is a pouch cell, and the wireless charging apparatus includes a power output module mating with the wireless charging device. The charging power of the wireless charging apparatus for the battery pack is greater than or equal to 15 W.

A battery pack applicable to a power tool includes a battery pack housing formed with a coupling portion for connecting the power tool; a cell unit disposed in the battery pack housing; a power management board disposed in the battery pack housing; a battery pack interface connected to the power tool to supply power to the power tool; and a wireless charging device configured to mate with a wireless charging apparatus to charge the cell unit. The wireless charging device is connected to the power management board. The battery pack interface is further configured to be detachably connected to a charger so that the charger charges the cell unit.

In an example, the charging power of the battery pack interface is greater than or equal to 30 W, and the maximum charging power of the wireless charging device is greater than 15 W.

In an example, the cell unit is a pouch cell.

In an example, the cell unit is a cylindrical cell.

A charging combination includes a battery pack, a first charging apparatus, and a second charging apparatus. The battery pack includes a battery pack housing; a cell unit disposed in the battery pack housing; a battery pack interface configured to be connected to a power tool to supply power to the power tool; and a wireless charging device configured to access power to charge the cell unit. The first charging apparatus includes a power output module mating with the wireless charging device. The second charging apparatus includes a second charging interface detachably connected to the battery pack interface. The battery pack interface includes a positive terminal and a negative terminal.

A battery pack applicable to a power tool includes a battery pack housing formed with a coupling portion for connecting the power tool; a cell unit disposed in the battery pack housing; a power management board disposed in the battery pack housing; a battery pack interface connected to the power tool to supply power to the power tool; a wireless charging device configured to mate with a wireless charging apparatus to charge the cell unit; and a Universal Serial Bus (USB) charging interface configured to be connected to a charger to charge the cell unit. The wireless charging device is connected to the power management board.

The USB interface is further configured to enable the battery pack to output power to another electrical apparatus.

In an example, the cell unit is a pouch cell.

In an example, the cell unit is a cylindrical cell.

A charging combination includes a first battery pack configured to power a power tool and including a first cell unit and a first wireless charging device able to charge the first cell unit; a second battery pack configured to power the power tool and including a second cell unit and a second wireless charging device able to charge the second cell unit; and a wireless charging apparatus configured to charge the first battery pack and the second battery pack simultaneously or in a preset order.

In an example, the first cell unit is a pouch cell and the second cell unit is the pouch cell.

In an example, the first cell unit is a pouch cell and the second cell unit is a cylindrical cell.

In an example, the first cell unit is a cylindrical cell and the second cell unit is the cylindrical cell.

A battery pack applicable to a power tool includes a battery pack housing formed with a coupling portion for connecting the power tool, wherein the battery pack is detachably connected to the power tool through the coupling portion; a cell unit for storing electrical energy and disposed in the battery pack housing; a power management board for controlling the battery pack and disposed in the battery pack housing; a battery pack interface connected to the power tool to supply power to the power tool; and a wireless discharge device configured to mate with an electrical apparatus to charge or power the electrical apparatus. The cell unit is a pouch cell. The wireless discharge device is connected to the power management board.

A battery pack applicable to a power tool includes a battery pack housing formed with a coupling portion for connecting the power tool, wherein the battery pack is detachably connected to the power tool through the coupling portion; a cell unit for storing electrical energy and disposed in the battery pack housing; a power management board for controlling the battery pack and disposed in the battery pack housing; a battery pack interface connected to the power tool to supply power to the power tool; and a wireless charging and discharging device configured to selectively mate with an electrical apparatus to charge or supply power to the electrical apparatus or mate with a wireless charging apparatus to enable the wireless charging apparatus to charge the cell unit. The cell unit is a pouch cell. The wireless charging and discharge device is connected to the power management board.

In an example, the wireless charging and discharging device has a charging mode and a discharging mode. When the wireless charging and discharging device is in the charging mode, the battery pack is charged by the wireless charging apparatus. When the wireless charging and discharging device is in the discharging mode, the battery pack charges or supplies power to the electrical apparatus.

### BRIEF DESCRIPTION OF THE DRAWINGS

FIG. 1 is a plan view of a power tool system according to an example of the present application.

FIG. 2 is a plan view of an electric drill in FIG. 1.

FIG. 3 is a plan view of a tool body and a battery pack of the electric drill in FIG. 2, where the tool body is separated from the battery pack.

FIG. 4 is a perspective view of part of a grip of the electric drill in FIG. 2.

FIG. 5 is a perspective view of a battery pack in FIG. 1.

FIG. 6A is a plan view of the battery pack in FIG. 5.

FIG. 6B is a cross-sectional view of the battery pack in FIG. 6A along a line A-A.

FIG. 6C is a sectional view of the battery pack in FIG. 6A along a line B-B.

FIG. 7A is a side view of the battery pack in FIG. 5.

FIG. 7B is a sectional view of the battery pack in FIG. 7A along a line C-C.

FIG. 8 is an exploded view of the battery pack in FIG. 5.

FIG. 9 is a perspective view of the structure shown in FIG. 8 from another viewing angle.

FIG. 10 is a plan view of cell units, a cell support, and a circuit board assembly in FIG. 8.

FIG. 11A is a perspective view of the structure shown in FIG. 10, where the circuit board assembly is separated from the cell support.

FIG. 11B is a perspective view of the structure shown in FIG. 11A from another viewing angle.

FIG. 12A is an exploded view of the structure shown in FIG. 10.

FIG. 12B is a perspective view of the structure shown in FIG. 12A from another viewing angle.

FIG. 13 is a cross-sectional view of a power tool in FIG. 2 in a plane P.

FIG. 14 is a perspective view of a charging combination of the present application.

FIG. 15 is a diagram illustrating modules of the charging combination shown in FIG. 14.

FIG. 16 is an exploded view of a battery pack according to another example of the present application.

FIG. 17 is a perspective view of another charging combination.

FIG. 18 is a plan view of the battery pack in FIG. 16.

FIG. 19 is a plan view of the battery pack in FIG. 16 and a fan.

FIG. 20 is a plan view of a charging combination according to another example of the present application.

FIG. 21 is a plan view of another power tool of the present application.

FIG. 22 is a perspective view of a battery pack according to another example of the present application.

FIG. 23 is a plan view of the battery pack in FIG. 22, where a first housing portion is separated.

FIG. 24 is an exploded view of the battery pack in FIG. 22.

FIG. 25 is a schematic view of cell units in the battery pack in FIG. 22.

FIG. 26 is a schematic view illustrating an arrangement of cell units in another battery pack of the present application.

FIG. 27 is an exploded view of a battery pack of another example.

FIG. 28 is a charging combination consisting of the battery pack in FIG. 27 and an electrical apparatus.

FIG. 29 is a system view consisting of a battery pack, an electrical apparatus, and a wireless charging device of another example.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

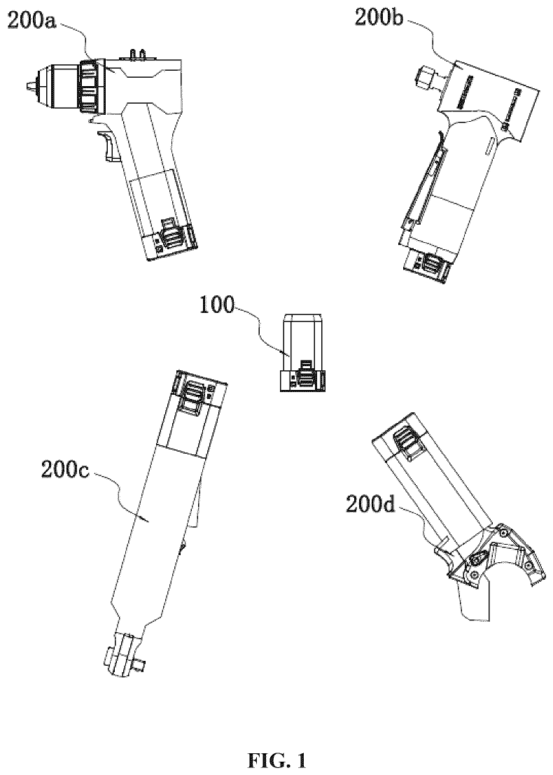

A battery pack 100 shown in FIG. 1 is used for powering a power tool. As an energy storage device, the battery pack 100 can transmit power to the power tool to power electrical components in the power tool. As shown in FIG. 1, the power tool may be an electric drill 200a, a grinder 200b, a wrench 200c, or a cutter 200d. It is to be understood that in other examples, the power tool may be a torque output tool such as a screwdriver, an impact drill, an electric hammer, or a ratchet wrench. The power tool may be a grinding tool such as an angle grinder, a sander, a straight grinder, or a polisher. The power tool may be a cutting tool such as an electric circular saw, a reciprocating saw, or a jigsaw. In some examples, the battery pack 100 may be configured to be detachably coupled to an electric fan, a lamp, or another apparatus to power these apparatuses, and the battery pack 100 may power an electric motor 212 for driving fan blades or a light-emitting element.

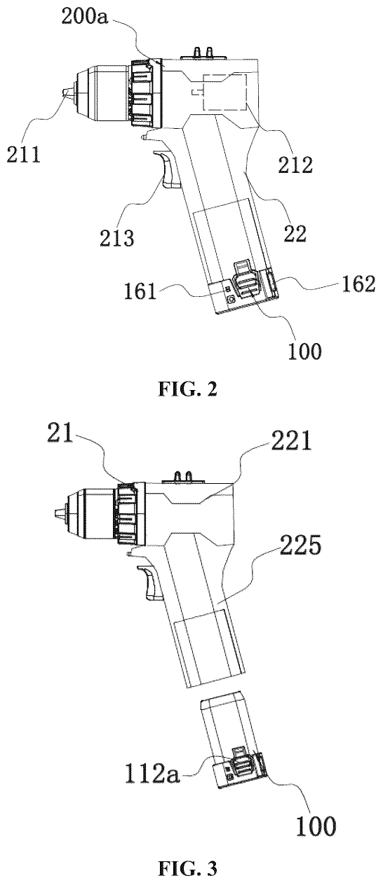

As shown in FIGS. 2 and 3, the electric drill 200a is used as a specific example of the power tool in this example. A power tool 200a is used instead of the electric drill 200a below.

The power tool 200a includes a tool body 21. The battery pack 100 is detachably connected to the tool body 21 to provide electrical energy for the tool body 21. The tool body 21 includes an output piece 211, an electric motor 212, and a body housing 22. The output piece 211 is used for implementing a function of the power tool 200a, and the output piece 211 outputs power. The output piece 211 may rotate or reciprocate. In this example, for the electric drill 200a, the output piece 211 may be connected to a drill bit to drive the drill bit to rotate. For another power tool 200a, the output piece 211 may be a bit, a blade, a saw blade, a saw band, a sanding base plate, or a grinding base plate. The electric motor 212 is used for driving the output piece 211 to rotate, and the electric motor 212 is disposed in the body housing 22. A transmission assembly may be disposed between the electric motor 212 and the output piece 211.

The body housing 22 is used for accommodating the electric motor 212. The body housing 22 includes an accommodation portion 221 for accommodating the electric motor 212. The battery pack 100 is detachably connected to the body housing 22. When the battery pack 100 is connected to the body housing 22, the battery pack 100 may be electrically connected to the electric motor 212 to supply power to the electric motor 212. The tool body 21 may further include a trigger 213 for starting the electric motor 212. When the trigger 213 is triggered by a user, the battery pack 100 outputs power to the electric motor 212 so that the electric motor 212 operates.

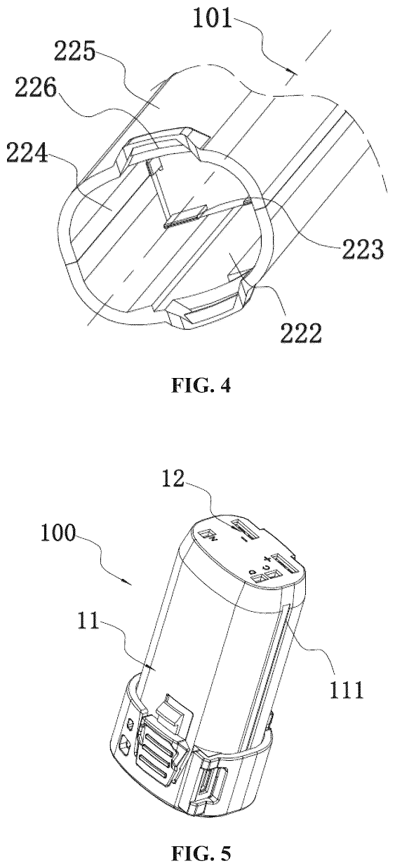

As shown in FIG. 4, the body housing 22 includes a coupling portion 222 and a body interface 223. The coupling portion 222 is used for detachably coupling the battery pack 100 to the tool body 21, and the body interface 223 is used for electrically connecting the battery pack 100. Correspondingly, as shown in FIG. 5, the battery pack 100 includes a mating portion 111 and a battery pack interface 12. The mating portion 111 mates with the coupling portion 222 to guide the battery pack 100 to be coupled to the body housing 22 along a direction of a first straight line 101. The battery pack interface 12 mates with the body interface 223 so that when the battery pack 100 is coupled to the body housing 22, the battery pack 100 is electrically connected to the tool body 21.

As shown in FIGS. 4 and 5, the body housing 22 is formed with an insertion slot 224, and the battery pack 100 is inserted into the insertion slot 224 along the direction of the first straight line 101. When the battery pack 100 is coupled to the body housing 22, part of the battery pack 100 is located in the insertion slot 224 so that a size of the entire power tool 200a can be reduced, facilitating the miniaturization of the power tool 200a. When the battery pack 100 is coupled to the body housing 22, part of the battery pack 100 is located outside the body housing 22 so that the user can conveniently mount and detach the battery pack 100 and can also conveniently observe the battery pack 100.

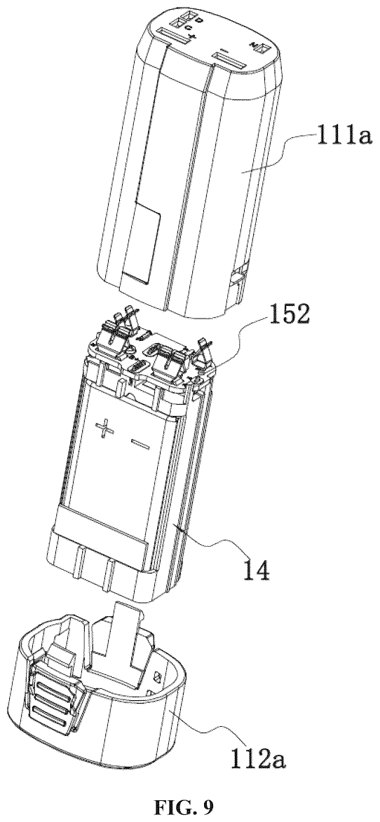

As shown in FIGS. 5 to 9, the battery pack 100 includes a battery pack housing 11, a cell unit 13, a cell support 14, and a circuit board assembly 15. The battery pack housing 11 forms a cell accommodation cavity 112 for accommodating the cell unit 13, the cell support 14, and the circuit board assembly 15. At least one cell unit 13 is provided. The cell unit 13 is used for storing electrical energy. For example, in the example shown in FIGS. 5 to 9, the number of cell units 13 is 2. In some examples, multiple cell units 13 may be provided, that is, the number of cell units 13 is greater than or equal to 2. It is to be understood that the number of cell units 13 is not limited thereto. The cell support 14 is used for supporting the cell unit 13. It is to be understood that in other examples, the cell support 14 may not be independently disposed, but the cell support 14 may be formed by the battery pack housing 11, where the battery pack housing 11 constitutes the cell support 14 that supports the cell unit 13. The circuit board assembly 15 is used for controlling a charging process and a discharging process of the battery pack 100.

In this example, the cell unit 13 is disposed in the battery pack housing 11, the cell unit 13 is electrically connected to the battery pack interface 12, and the cell unit 13 supplies power to the electric motor 212 through the battery pack interface 12. The cell unit 13 is a pouch cell. The pouch cell includes a packaging bag and an electrolyte disposed in the packaging bag. The pouch cell is easy to deform, so the cell support 14 can maintain the shape of the pouch cell to a certain extent. The pouch cell has a volumetric energy density greater than or equal to 0.4 Wh/cm³. In some examples, the pouch cell has a volumetric energy density greater than or equal to 0.42 Wh/cm³. In some examples, the pouch cell has a volumetric energy density greater than or equal to 0.44 Wh/cm³. In some examples, the pouch cell has a volumetric energy density greater than or equal to 0.45 Wh/cm³. In some examples, the pouch cell has a volumetric energy density greater than or equal to 0.46 Wh/cm³. In some examples, the pouch cell has a volumetric energy density greater than or equal to 0.48 Wh/cm³. In some examples, the pouch cell has a volumetric energy density greater than or equal to 0.5 Wh/cm³. In some examples, the pouch cell has a volumetric energy density greater than or equal to 0.51 Wh/cm³. In some examples, the pouch cell has a volumetric energy density greater than or equal to 0.52 Wh/cm³. In some examples, the pouch cell has a volumetric energy density greater than or equal to 0.53 Wh/cm³.

In some examples, the battery pack 100 has a nominal voltage greater than or equal to 3 V and less than or equal to 9 V. For the power tool 200a and the battery pack, the nominal voltage generally refers to a voltage specified by the manufacturer or the vendor on the label, packaging, user manual, specification, advertisement, marketing document, or another support document of the product so that the user knows which power tool 200a can operate with the battery pack. Alternatively, the nominal voltage of the battery pack 100 may be detected or calculated. A voltage of a single cell unit 13 is generally 3.6 V to 4.2 V. In the example shown in FIGS. 5 to 9, the battery pack 100 includes two cell units 13, each cell unit 13 has a voltage of basically 4 V, and the two cell units 13 are connected in series. Therefore, the nominal voltage of the battery pack 100 may be considered 8 V. It is to be understood that the nominal voltage of the battery pack 100 is related to the number of cell units 13 connected in series in the battery pack 100. For example, when the number of cell units 13 in the battery pack 100 is 1, the nominal voltage of the battery pack 100 may be considered 3.6 V to 4.2 V and specifically, 3.6 V, 4 V, or 4.2 V.

In some examples, the nominal voltage of the battery pack is greater than or equal to 3 V and less than or equal to 17 V. Similarly, when the number of cell units 13 connected in series in the battery pack 100 is 3, the nominal voltage of the battery pack 100 may be considered 10.8 V to 12.6 V and specifically, 10.8 V, 12 V, or 12.6 V. Similarly, when the number of cell units 13 connected in series in the battery pack 100 is 4, the nominal voltage of the battery pack 100 may be considered 14.4 V to 16.8 V and specifically, 14.4 V, 16 V, or 16.8 V.

In this example, the battery pack 100 has a nominal voltage greater than or equal to 7 V and less than or equal to 9 V. For example, in this example, if the number of cell units 13 is 2 and the two cell units 13 are connected in series, the nominal voltage of the battery pack 100 may be considered 7.2 V to 8.4 V and specifically, 7.2 V, 8 V, or 8.4 V.

In some other examples, the number of cell units 13 in the battery pack 100 is less than or equal to 4. Four cell units 13 may be connected in series. Alternatively, the four cell units 13 may constitute two cell groups, the two cell groups are connected in parallel, and two cell units 13 in each cell group are connected in series. When four cells constitute two cell groups, similarly, the nominal voltage of the battery pack 100 may be considered 8 V. In some examples, the battery pack 100 has a nominal voltage less than or equal to 9 V. In some examples, the battery pack 100 has a nominal voltage greater than or equal to 7 V.

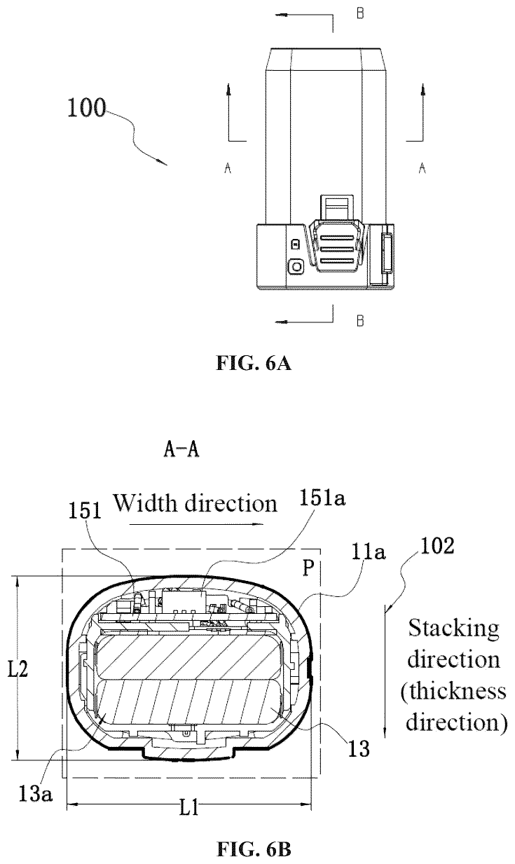

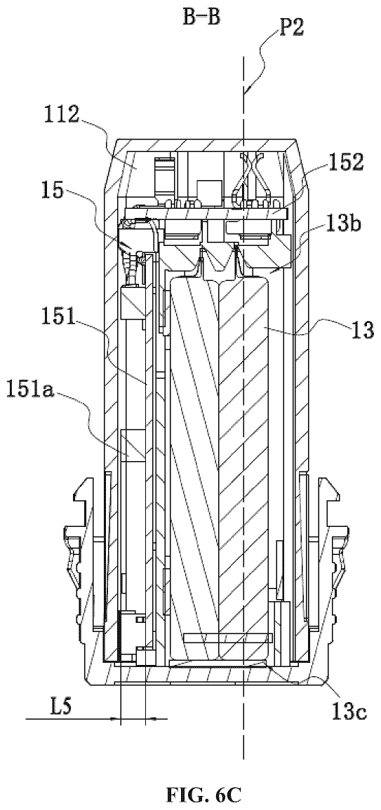

In some examples, the battery pack 100 has a nominal voltage less than or equal to 13 V. For example, the battery pack 100 includes three cell units 13 connected in series, and the nominal voltage of the battery pack 100 may be 10.8 V, 12 V, or 12.6 V. As shown in FIGS. 6B and 6C, multiple cell units 13 are stacked in the battery pack housing 11. Here, a direction perpendicular to the cell units 13 may be defined as a stacking direction 102 of the multiple cell units 13. That is to say, the multiple cell units 13 are stacked in sequence along the stacking direction 102. In this example, the stacking direction 102 of the multiple cell units 13 is perpendicular to the direction of the first straight line 101 along which the battery pack 100 is coupled to the tool body 21.

In this example, the battery pack 100 is detachably connected to the tool body 21. In fact, in other examples, it is to be understood that the battery pack may be built into the body housing, and the battery pack is used for powering the electric motor. The battery pack includes at least one cell unit, the cell unit is used for storing electrical energy and disposed in a grip, and an extension plane of the cell unit is parallel to the direction of the first straight line. All technical solutions of the present application that are applicable to the battery pack built into the body housing can be applied to power tools with built-in battery packs. The details are not repeated.

As shown in FIGS. 3 and 4, the power tool 200a is a handheld power tool 200a, the body housing 22 further includes a grip 225, and the grip 225 is used for the user to hold. The grip 225 is connected to the accommodation portion 221 and extends from the accommodation portion 221 along the direction of the first straight line 101. An extension direction of the grip 225 intersects an extension direction of the accommodation portion 221. The battery pack 100 is coupled to the grip 225 along the extension direction of the grip 225. One end of the grip 225 is connected to the accommodation portion 221 and the other end of the grip 225 forms the preceding insertion slot 224. The insertion slot 224 is disposed in the grip 225 and formed by the grip 225. In other words, a slot wall forming the insertion slot 224 constitutes part of the grip 225. When the user holds the power tool 200a, a hand of the user holds an outer wall of the insertion slot 224. When the battery pack 100 is coupled to the tool body 21, part of the battery pack housing 11 is disposed in the insertion slot 224 formed by the grip 225, and part of the cell unit 13 is also located in the insertion slot 224 formed by the grip 225. In this manner, the battery pack 100 is partially located in the grip 225. When the user operates the power tool 200a, the battery pack 100 is partially located in a grip space surrounded by the palm and fingers of the user.

It is to be understood that, as shown in FIG. 1, when the power tool is the ratchet wrench 200c or the cutter 200d in FIG. 1, the extension direction of the accommodation portion is substantially the same as the extension direction of the grip and the body housing is basically linear. The battery pack 100 is coupled to the grip along the extension direction of the grip. In this example, the battery pack 100 is also basically linear. In this manner, when the battery pack 100 is coupled to the grip, part of the battery pack 100 is located in the grip so that the entire power tool can have a relatively small volume, and the entire power tool is also basically linear.

In this example, the cell unit 13 is the pouch cell, and the nominal voltage of the battery pack 100 is less than or equal to 9 V. Thus, the battery pack 100 has a relatively small volume so that when the battery pack 100 is partially disposed in the grip 225, the grip 225 is still relatively thin, making it convenient for the user to operate the power tool 200a. Moreover, the battery pack 100 is partially disposed in the grip 225 so that space in the grip 225 can be fully utilized and the size of the entire power tool 200a can be reduced, facilitating the miniaturization of the power tool 200a.

In some examples, the battery pack may have a nominal voltage less than or equal to 17 V.

In this example, the output power of the battery pack 100 is greater than or equal to 140 W and less than or equal to 750 W. The output power is calculated based on the rated current of the battery pack 100 and the nominal voltage of the battery pack 100. The rated current of the battery pack 100 may be an average working current of the power tool 200a. Similarly, it is to be understood that the output power of the battery pack 100 may be considered working power of the power tool 200a. For the power tool 200a, the average working current is generally within a range, and the corresponding working power may vary within a certain range. For example, in this example, the power tool 200a is the electric drill 200a, an average current of the electric drill 200a is 21 A to 48 A, and the nominal voltage of the battery pack 100 is 8 V. Therefore, the working power of the power tool 200a is 168 W to 384 W, and the output power of the battery pack 100 may be considered 168 W to 384 W.

In this manner, the nominal voltage of the battery pack 100 is 8 V, and the battery pack 100 can satisfy the requirement of the power tool 200a with relatively large power, thereby improving the adaptability of the battery pack 100.

In some examples, the output power of the battery pack 100 is greater than or equal to 140 W and less than or equal to 600 W. In some examples, the output power of the battery pack 100 is greater than or equal to 150 W and less than or equal to 550 W.

In some examples, the battery pack 100 has a volumetric energy density greater than or equal to 100 mWh/cm³ and a nominal voltage less than or equal to 9 V. In this manner, for the battery pack 100 with a low voltage, the battery pack 100 can provide a smaller volume and more energy so that the energy of the battery pack 100 is increased when the requirement of the power tool 200a for a low voltage platform is satisfied, thereby extending the battery life of the battery pack 100. The volumetric energy density is the ratio of the energy to volume of the battery pack 100. The volume of the battery pack 100 may refer to an amount of three-dimensional (3D) space occupied by the entire battery pack 100 and is expressed in cubic units (for example, cubic centimeters (cm³) or cubic millimeters (mm³)). The total volume of the battery pack 100 may be measured in different manners, including a volume of water discharged when the entire battery pack 100 sealed is immersed in water. The volume of the battery pack 100 may be measured in other manners commonly used by those skilled in the art.

In some examples, the battery pack 100 has a volumetric energy density greater than or equal to 120 mWh/cm³. In some examples, the battery pack 100 has a volumetric energy density greater than or equal to 130 mWh/cm³.

In some examples, it may be further defined that the battery pack 100 has a gravimetric energy density greater than or equal to 100 mWh/g. The gravimetric energy density is the ratio of the energy to weight of the battery pack 100. In this manner, the overall weight of the battery pack 100 can be reduced in the case where the battery pack 100 provides a sufficient battery life.

In some examples, the battery pack has a gravimetric energy density greater than or equal to 110 mWh/g. In some examples, the battery pack has a gravimetric energy density greater than or equal to 120 mWh/g.

In this example, the number of cell units 13 included in the battery pack 100 is 2, and the volume of the battery pack 100 is less than or equal to 250 cm³. The weight of the battery pack 100 is less than or equal to 200 g. In some examples, the weight of the battery pack is less than or equal to 180 g. In some examples, the weight of the battery pack is less than or equal to 150 g. In some examples, the weight of the battery pack is less than or equal to 140 g. In some examples, the volume of the battery pack is less than or equal to 200 cm³. In some examples, the volume of the battery pack is less than or equal to 180 cm³. In some examples, the volume of the battery pack is less than or equal to 150 cm³. In some examples, the volume of the battery pack is less than or equal to 130 cm³.

In some examples, the capacity of the battery pack 100 is greater than or equal to 1.5 Ah and less than or equal to 5 Ah. The energy of the battery pack 100 is greater than or equal to 7 Wh and less than or equal to 9 Wh. In this manner, the total capacity of the battery pack 100 is relatively large so that the battery life of the battery pack 100 can be extended.

In some examples, the ratio of the output power of the battery pack 100 to the volume of the battery pack 100 is greater than or equal to 1 W/cm³. Here, the ratio of the output power of the battery pack 100 to the volume of the battery pack 100 may be defined as a power density. In this example, the cell unit 13 is the pouch cell, and the volume of the battery pack 100 can be reduced when the output power of the battery pack 100 is increased. Thus, when the power tool 200a satisfies the working power, the volume of the battery pack 100 can be reduced and the battery life of the battery pack 100 can be extended.

In some examples, the ratio of the output power of the battery pack 100 to the volume of the battery pack 100 is greater than or equal to 1.1 W/cm³.

FIG. 6B shows a cross-section of a portion of the battery pack 100 in the insertion slot 224 of the grip 225 in a plane P perpendicular to the direction of the first straight line 101. As shown in FIG. 6B, the cross-section of the battery pack 100 in the plane P perpendicular to the first straight line 101 has an outer contour 11a, and the outer contour 11a is as indicated by a bold line in FIG. 6B. The perimeter of the outer contour 11a is greater than or equal to 10 cm and less than or equal to 14 cm. The perimeter of the outer contour 11a may be measured by a rope winding method, and the length of a rope forming one circle around the outer contour 11a may be defined as the perimeter of the outer contour 11a. It is to be understood that those skilled in the art may measure the perimeter by other common methods. In this manner, for the handheld power tool 200a, the battery pack 100 is relatively thin so that the battery pack 100 is relatively suitable for insertion into the grip 225 without increasing the size of the grip 225, and the space in the grip 225 can be effectively utilized. Especially for the power tool 200a with a low voltage platform, the size of the power tool 200a is desired to be small enough when the power tool 200a satisfies the working power. In some examples, the perimeter of the outer contour 11a is greater than or equal to 11 cm and less than or equal to 13.5 cm.

As shown in FIG. 6B, the area of the outer contour 11a of the cross-section of the battery pack 100 in the plane perpendicular to the first straight line 101 is greater than or equal to 8 cm² and less than or equal to 14 cm². In this manner, the battery pack 100 is relatively small in size and convenient for the user to hold, and the battery pack 100 is prevented from being too small to conveniently accommodate the cell units 13, the circuit board assembly 15, and other components inside. The area may be measured by a method commonly used by those skilled in the art, such as a grid method. The grid method includes simulating the outer contour 11a, dividing the outer contour 11a into several grid squares, calculating the area of each square, and summing the areas of several grid squares to approximately obtain the area of the outer contour 11a. Of course, those skilled in the art may use other measurement methods as long as the area of the outer contour 11a can be approximately estimated. In some examples, the area of the outer contour of the cross-section of the battery pack in the plane perpendicular to the first straight line is greater than or equal to 10 cm² and less than or equal to 12.5 cm².

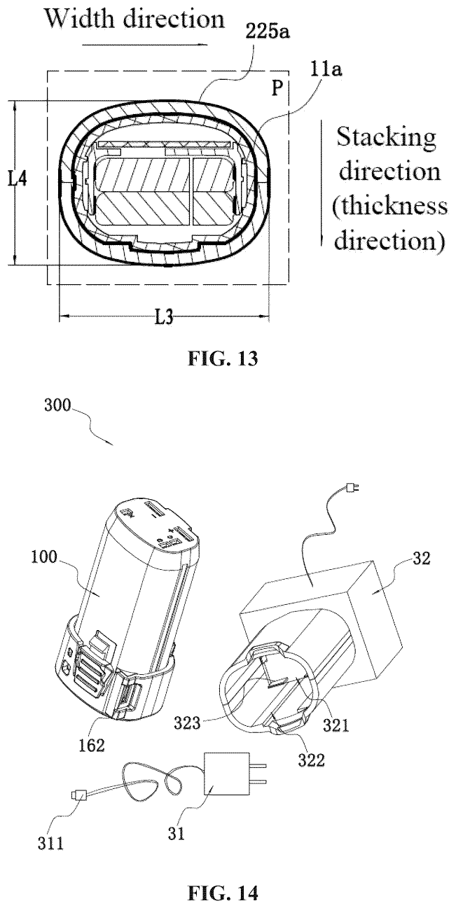

FIG. 13 shows cross-sections of the grip 225 and the battery pack 100 in the grip 225 in the plane P. In the cross-sectional view, the inner bold line indicates the outer contour 11a of the battery pack 100, and the outer bold line indicates an outer contour 225a of the grip 225. In this example, since the outer contour 11a of the cross-section of the battery pack 100 in the plane P is relatively small in size, the outer contour 225a of a cross-section of the grip 225 in the plane P can be designed to be relatively small. For example, the perimeter of the outer contour 225a of the cross-section of the grip 225 in the plane P perpendicular to the first straight line 101 is greater than or equal to 12.5 cm and less than or equal to 16 cm. The area of the outer contour 225a of the cross-section of the grip 225 in the plane P perpendicular to the first straight line 101 may be greater than or equal to 13 cm² and less than or equal to 18 cm². In this manner, the grip 225 is not only thin to reduce a grip contact surface but also is prevented from being too thick to be comfortable to hold. In some examples, the perimeter of the outer contour 225a of the cross-section of the grip 225 in the plane P perpendicular to the first straight line 101 is greater than or equal to 13 cm and less than or equal to 15 cm. In some examples, the area of the outer contour 225a of the cross-section of the grip 225 in the plane P perpendicular to the first straight line 101 is greater than or equal to 14 cm² and less than or equal to 16.5 cm².

As shown in FIG. 6B, in a width direction perpendicular to the first straight line 101, a dimension L1 of the cross-section of the battery pack 100 in the plane P is greater than or equal to 3.7 cm and less than or equal to 4.7 cm. In this manner, the width of the grip 225 is suitable for the user to hold comfortably and stably. In a thickness direction perpendicular to the first straight line 101 and the width direction, a dimension L2 of the cross-section of the battery pack 100 in the plane P is greater than or equal to 2.7 cm and less than or equal to 3.7 cm. The dimension of the cross-section in the width direction is greater than the dimension of the cross-section in the thickness direction. For example, the ratio of the dimension L1 of the cross-section in the width direction to the dimension L2 of the cross-section in the thickness direction is greater than or equal to 1.1 and less than or equal to 1.5. In some examples, the ratio of the dimension L1 of the cross-section in the width direction to the dimension L2 of the cross-section in the thickness direction is greater than or equal to 1.2 and less than or equal to 1.5. In this manner, the cross-section of the battery pack 100 can be basically elliptical so that the grip 225 for accommodating the battery pack 100 is conveniently designed to be approximately elliptical. In some examples, in the width direction perpendicular to the first straight line 101, the dimension L1 of the cross-section of the battery pack 100 in the plane P is greater than or equal to 3.9 cm and less than or equal to 4.5 cm and in the thickness direction perpendicular to the first straight line 101 and the width direction, the dimension L2 of the cross-section of the battery pack 100 in the plane P is greater than or equal to 2.9 cm and less than or equal to 3.5 cm.

As shown in FIG. 13, in the width direction perpendicular to the first straight line 101, a dimension L3 of the cross-section of the grip 225 in the plane P is greater than or equal to 4.5 cm and less than or equal to 5.3 cm. In this manner, the width of the grip 225 is suitable for the user to hold comfortably and stably. In the thickness direction perpendicular to the first straight line 101 and the width direction, a dimension L4 of the cross-section of the grip 225 in the plane P is greater than or equal to 3.5 cm and less than or equal to 4.5 cm. The dimension of the cross-section in the width direction is greater than the dimension of the cross-section in the thickness direction. For example, the ratio of the dimension L1 of the cross-section in the width direction to the dimension L2 of the cross-section in the thickness direction is greater than or equal to 1.1 and less than or equal to 1.5. In some examples, the ratio of the dimension L1 of the cross-section in the width direction to the dimension L2 of the cross-section in the thickness direction is greater than or equal to 1.2 and less than or equal to 1.5. In this manner, the cross-section of the grip 225 can be basically elliptical so that the user can comfortably operate the power tool 200a, and the ergonomics of the power tool 200a is considered.

As shown in FIGS. 4 to 7B, the cell unit 13 is the pouch cell, and the pouch cell extends in an extension plane P2. Alternatively, it is to be understood that a plane where the largest surface of the pouch cell is located is the extension plane P2. The extension plane of the cell unit 13 is basically parallel to the first straight line 101. The extension direction of the grip 225 is the first straight line 101, the grip 225 has the largest dimension in the direction of the first straight line 101, and the plane where the largest surface of the cell unit 13 is located is the extension plane. In this manner, most of the cell unit 13 is located in the grip 225 and the extension plane is basically consistent with the first straight line 101 so that the volume of a whole formed by the grip 225 and the battery pack 100 can be reduced, and the cell unit 13 can fully utilize space formed by the grip 225 in the direction of the first straight line 101.

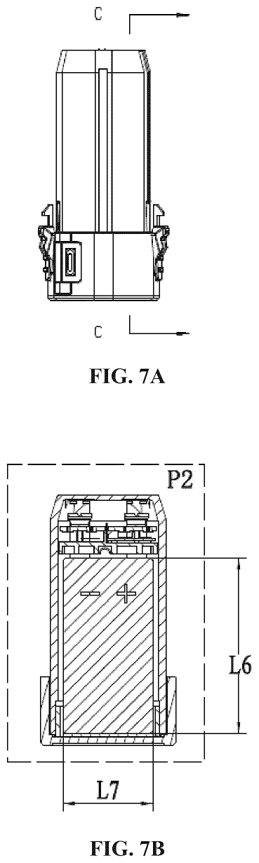

As shown in FIG. 7B, the cell unit 13 is basically rectangular, the length L6 of the cell unit 13 is greater than or equal to 5.7 cm and less than or equal to 6.7 cm, and the width L7 of the cell unit 13 is greater than or equal to 2.7 cm and less than or equal to 3.7 cm. The length L6 of the cell unit 13 is a dimension of the cell unit 13 along the direction of the first straight line 101, and the width L7 of the cell unit 13 is a dimension of the cell unit 13 along a direction perpendicular to the first straight line 101 and parallel to the extension plane of the cell unit 13. In some examples, the length L6 of the cell unit 13 is greater than or equal to 5.9 cm and less than or equal to 6.9 cm, and the width L7 of the cell unit 13 is greater than or equal to 2.9 cm and less than or equal to 3.9 cm.

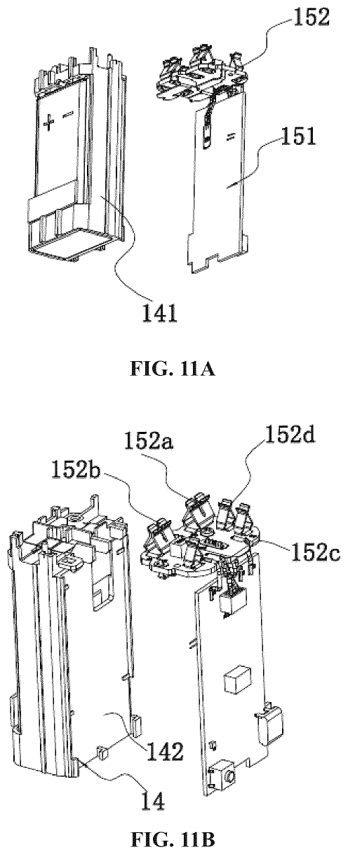

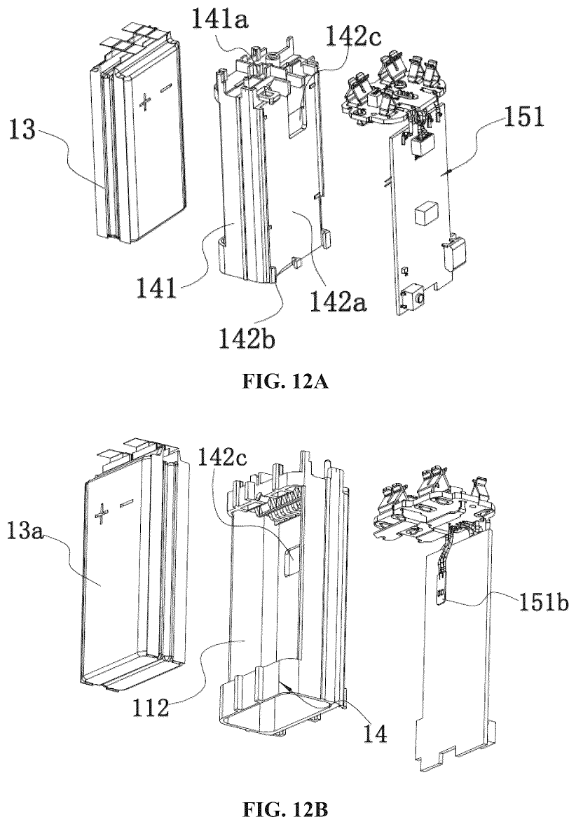

As shown in FIGS. 6A to 12B, the circuit board assembly 15 is used for controlling the battery pack 100 to be charged and discharge and protecting the battery pack 100. The circuit board assembly 15 is disposed in the battery pack housing 11. Multiple electronic elements are disposed on the circuit board assembly 15.

The circuit board assembly 15 includes a power management board 151. The power management board 151 is configured to manage a relationship between the multiple cell units 13 and control charging and discharging parameters and processes of the battery pack 100. An extension plane of the power management board 151 is basically parallel to the extension plane of the cell unit 13 in the grip 225. In this manner, space on the left and right sides of the cell units 13 can be fully utilized so that the power management board 151 and the cell units 13 fully utilize space in an ellipse.

The power management board 151 is stacked on a side surface of the cell units 13 in the grip 225, and the extension plane of the power management board 151 is also parallel to the direction of the first straight line 101 of the grip 225. It is to be noted that side surfaces of the cell units 13 may be understood as regions of the cell units 13 on two sides of the extension plane. In this example, the two cell units 13 are both parallel to the power management board 151.

In this example, the cell units 13 at least partially located in the grip 225 are defined as a first group of cells 13a. Along the direction of the first straight line 101, the first group of cells 13a includes a first end 13b and a second end 13c, the first end 13b is an end of the first group of cells 13a facing the body interface 223, the second end 13c is opposite to the first end 13b, and the second end 13c is an end of the first group of cells 13a facing away from the body interface 223. When the battery pack 100 is coupled to the grip 225, the first end 13b is located in the grip 225, and the second end 13c is located outside the grip 225. That is to say, when the battery pack 100 is coupled to the grip 225, the first end 13b is located in the insertion slot 224, and the second end 13c is located outside the insertion slot 224. The battery pack interface 12 is disposed at the first end 13b of the first group of cells 13a. In this manner, when the battery pack 100 is inserted into the insertion slot 224, the battery pack interface 12 first enters the insertion slot 224. When the battery pack 100 is inserted to the bottom of the insertion slot 224, the battery pack interface 12 at the first end 13b can be connected to the body interface 223 at the bottom of the insertion slot. Thus, when the battery pack 100 is inserted to the bottom of the insertion slot, the battery pack interface 12 is stably connected to the body interface 223. In this manner, not only can the battery pack 100 be more stably connected to the tool body 21, but also the body interface 223 and the battery pack interface 12 can be protected from interference of an external environment.

The circuit board assembly 15 further includes a terminal circuit board 152. The battery pack interface 12 includes at least one terminal of the battery pack 100. For example, the battery pack interface 12 may include a positive terminal 152a and a negative terminal 152b and may also include a detection terminal 152c and a communication terminal 152d. The terminal circuit board 152 is used for supporting and mounting the terminals of the battery pack 100, that is, the positive terminal 152a, the negative terminal 152b, the detection terminal 152c, and the communication terminal 152d. The positive terminal 152a and the negative terminal 152b are connected to the cell units 13. In this example, the terminal circuit board 152 is disposed at the first end 13b of the first group of cells 13a so that the battery pack interface 12 can be conveniently disposed at a position of the battery pack 100 facing the bottom of the insertion slot 224, and dimensions of the battery pack 100 in directions in the plane P perpendicular to the first straight line 101 can be reduced, facilitating a design of the grip 225 suitable for the user to hold.

The terminal circuit board 152 extends basically along a direction perpendicular to the first straight line 101 so that space at the first end 13b of the first group of cells 13a can be fully utilized. It is to be understood that in other examples, the terminal circuit board 152 may be obliquely disposed relative to the first straight line 101.

In this example, the extension plane P2 of the cell unit 13 may be defined as a first plane. The power management board 151 and the terminal circuit board 152 are disposed separately, and the power management board 151 is disposed on a side surface of the first group of cells 13a and is parallel to the first plane. As is known, the terminal of the battery pack 100 generally has a certain length. Therefore, the terminals of the battery pack 100 are disposed at an end of the cell units 13 rather than the side surface of the cell units 13 so that the dimensions of the battery pack 100 in the plane P perpendicular to the first straight line 101 can be reduced and the space of the grip 225 in the direction of the first straight line 101 can be fully utilized. An extension plane of the terminal circuit board 152 is not parallel to the extension plane of the power management board 151. For example, in this example, the extension plane of the terminal circuit board 152 is basically perpendicular to the extension plane of the power management board 151. The terminal circuit board 152 is located at an end of the cell units 13 stacked along the stacking direction 102. Thus, the terminals of the battery pack 100 are located at an end of long sides of a rectangle.

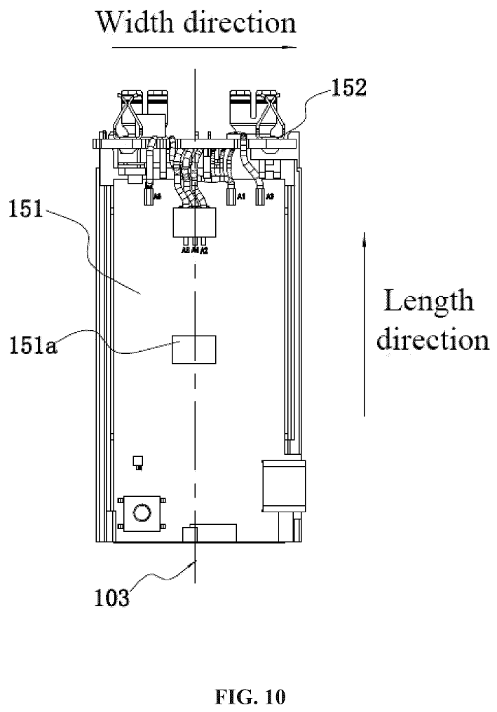

As shown in FIGS. 6B, 6C, and 10, the power management board 151 has an element 151a, and the element 151a is mounted on a side of the power management board 151 facing away from the cell units 13. The volume of the element 151a is greater than or equal to 100 mm³, and the element 151a is disposed on a central axis 103 of the power management board 151 in a length direction or width direction. A dimension L5 of the element 151a in a direction perpendicular to the extension plane is greater than or equal to 3 mm, where the length direction is consistent with the direction of the first straight line 101, and the length direction is perpendicular to the width direction and the thickness direction. For example, in this example, the element 151a is disposed on the central axis 103 of the power management board 151 in the width direction so that a raised space in the middle of the ellipse can be fully utilized, and the volumetric energy density of the battery pack 100 can be increased. In this example, the dimension L5 of the element 151a in the direction perpendicular to the extension plane is greater than or equal to 3 mm. The height of the element 151a is relatively high. If the element 151a is mounted at another position of the power management board 151, the battery pack 100 may have a relatively large size. The element 151a with a relatively high height may be, for example, a capacitor or an inductor.

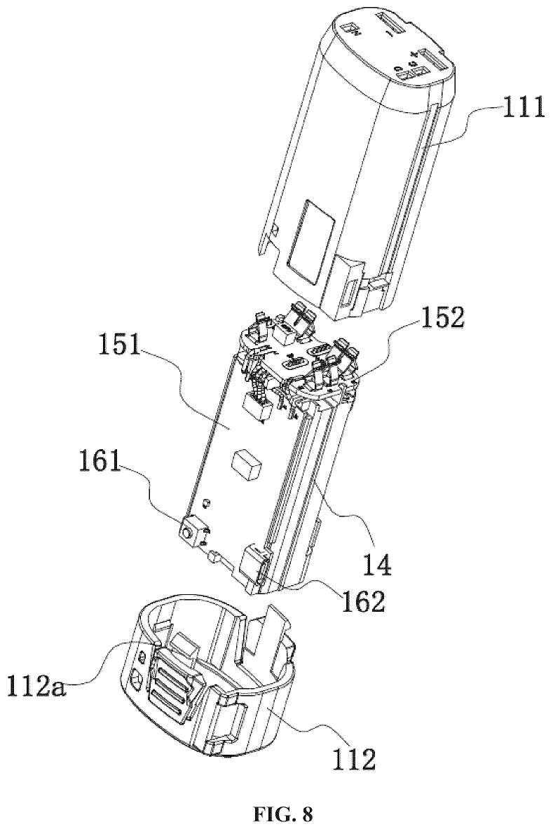

As shown in FIGS. 8 to 12B, the cell support 14 is used for supporting the cell units 13. In this example, the cell support 14 includes a first support portion 141 and a second support portion 142, and the first support portion 141 is disposed on four end surfaces of the cell units 13.

The first support portion 141 surrounds the four end surfaces of the cell units 13 to form the cell accommodation cavity 112. One side of the cell accommodation cavity 112 is opened to improve the heat dissipation effect of the cell units 13, and the second support portion 142 is disposed on the other side of the cell accommodation cavity 112.

The second support portion 142 is disposed on a side surface of the cell units 13. The first support portion 141 includes a terminal board support portion 141a disposed at the first end 13b of the cell units 13, and an outer side of the terminal board support portion 141a facing away from the cell units 13 is used for supporting the terminal circuit board 152. An inner side of the second support portion 142 faces a surface of the cell units 13, and an outer side of the second support portion 142 is used for mounting the power management board 151. A groove 142a and a clamping portion 142b may be formed on the outer side of the second support portion 142. The groove 142a is used for accommodating at least part of the power management board 151, and the clamping portion 142b is used for fixing the power management board 151. A detection device 151b is provided on a side of the power management board 151 facing the second support portion 142. The detection device 151b and the preceding element 151a are disposed on different sides of the power management board 151, separately. The detection device 151b is configured to detect the temperature of the cell units 13. The detection device 151b is disposed on the side of the power management board 151 facing the cell units 13 to achieve more accurate temperature detection. The second support portion 142 is further provided with a through hole 142c, and the through hole 142c makes space on two sides of the second support portion 142 interconnected. The detection device 151b is disposed at a position of the power management board 151 that is directly opposite to the through hole 142c. The detection device 151b may be located in the through hole 142c or may even pass through the through hole 142c and be located on a side of the second support portion 142 facing the cell units 13 so that the detection device 151b is closer to the surface of the cell units 13. For example, the detection device 151b may be in contact with the surface of the cell units 13 so that the temperature of the cell units 13 can be detected more accurately.

As shown in FIGS. 3, 8, and 9, the battery pack housing 11 includes a first housing portion 111 and a second housing portion 112, and the first housing portion 111 and the second housing portion 112 are detachably connected to each other along the direction of the first straight line 101. In this manner, the battery pack 100 can be mounted conveniently. The first housing portion 111 forms a first barrel portion 111a, the first barrel portion 111a extends along the direction of the first straight line 101, an end of the first barrel portion 111a facing the second housing portion 112 is opened, and the terminals of the battery pack 100 are disposed at an end of the first barrel portion 111a facing away from the second housing portion 112. An end portion of the first barrel portion 111a facing away from the second housing portion 112 is partially closed and formed with through holes 142c that allow tool terminals or the terminals of the battery pack 100 to penetrate through. The second housing portion 112 forms a second barrel portion 112a. After the second barrel portion 112a is engaged with the first barrel portion 111a, the cell accommodation cavity 112 for accommodating the cell units 13 is formed. An end of the second barrel portion 112a facing the first barrel portion 111a is opened, and the other end of the second barrel portion 112a is at least partially closed. A dimension of the first housing portion 111 along the direction of the first straight line 101 is greater than a dimension of the second housing portion 112 along the direction of the first straight line 101.

A locking structure 112b is formed on an outer wall of the second barrel portion 112a. The locking structure 112b is adapted to a mating structure 226 on the body housing 22 so that the battery pack 100 can be locked when the battery pack 100 is coupled to the body housing 22, thereby preventing the battery pack 100 from being disengaged from the power tool 200a due to vibration and ensuring the stability of a connection between the battery pack interface 12 and a tool interface. Specifically, the locking structure 112b is a buckle.

As shown in FIGS. 2, 5, and 8, the battery pack 100 further includes a power display component 161 and a first interface 162, where the first interface 162 is used for connecting an external charging apparatus so that the power tool 200a is charged by the external charging apparatus. The power display component 161 is configured to display the remaining power of the battery pack 100. The power display component 161 and the first interface 162 are both disposed on the side of the power management board 151 facing away from the cell units 13. The first interface 162 is configured in such a manner that the charging apparatus is coupled to the first interface 162 along a direction parallel to the power management board 151 and perpendicular to the first straight line 101.

The first interface 162 is at least partially disposed on the battery pack housing 11 and specifically on the second housing portion 112. When the battery pack 100 is coupled to the tool body, the first interface 162 is located outside the body housing. In this manner, the user can charge the battery pack 100 without detaching the battery pack 100. In this example, when the battery pack 100 is coupled to the grip 225, the first interface 162 is located outside the grip 225.

The first interface 162 is a USB charging interface. The USB charging interface can not only be used for charging but also output power to power another electrical apparatus. In some examples, the first interface 162 is a Type-C interface. The first interface 162 is configured to be the Type-C interface so that the battery pack 100 can be adapted to more types of charging apparatuses. The charging apparatuses may be a dedicated charger manufactured by the manufacturer of the battery pack 100 and matching the battery pack 100 and a common Type-C universal charger on the market. In this example, the cell unit 13 in the battery pack 100 is the pouch cell so that the battery pack 100 has a relatively large volumetric energy density. Thus, the battery pack 100 can not only power the power tool 200a but also have a sufficiently long battery life to charge another electrical apparatus. That is to say, the first interface 162 can also output power so that the battery pack 100 can power another electrical apparatus.

As shown in FIG. 14, a charging combination 300 includes a battery pack 100 and a first charger 31. The battery pack 100 is the battery pack 100 in FIGS. 1 to 3. The first charger 31 is adapted to the first interface 162, and the first charger 31 includes a first charging interface 311 detachably connected to the first interface 162. The first charger 31 is a Type-C charger and the first charging interface 311 is a Type-C interface.

In some examples, the first charger 31 is a common Type-C universal charger on the market, and the Type-C universal charger can charge mobile phones. The charging power of the first charger 31 is less than or equal to 15 W.

Alternatively, in some examples, the charging power of the first charger 31 is greater than or equal to 15 W. Alternatively, the charging power of the first charger 31 is greater than or equal to 18 W. In this manner, a time for charging the battery pack 100 can be shortened.

When the battery pack 100 is mounted to the tool body 21, the first interface 162 is further configured to allow access to electrical energy to charge the battery pack 100. That is, when the battery pack 100 is mounted to the tool body 21, the first charger 31 may charge the battery pack 100. In this manner, the user can directly charge the battery pack 100 through the first charger 31 without detaching the battery pack 100. Alternatively, when the power tool 200a is in operation, the first interface 162 allows the access to electrical energy to charge the battery pack 100 so that the user can directly charge the battery pack 100 that is not detached, and an effect of charging and using the battery pack 100 at the same time can be achieved.

In some examples, the battery pack interface 12 may also be configured as a charging interface. The battery pack interface 12 is connected to the external charging apparatus to charge the battery pack 100. As shown in FIG. 14, the charging combination 300 further includes a second charger 32, and the second charger 32 includes a second charging interface 321 detachably connected to the battery pack interface 12 to charge the battery pack 100. That is to say, the battery pack interface 12 can be configured to output power to charge the power tool 200a and also configured to access power to charge the cell units 13. The charging power of the battery pack interface 12 is greater than or equal to 30 W.

The second charger 32 is formed with a charging coupling portion 322. The battery pack 100 can be coupled to the charging coupling portion 322. The charging coupling portion 322 is configured with charging terminals 323 connected to the terminals of the battery pack 100. The charging coupling portion 322 may be a structure similar to the insertion slot 224 of the grip 225. In this manner, when the battery pack 100 is coupled to the second charger 32, the battery pack interface 12 is electrically connected to the second charging interface 321. The charging power of the second charger 32 is greater than or equal to 30 W. In some examples, the charging power of the second charger 32 is greater than or equal to 40 W.

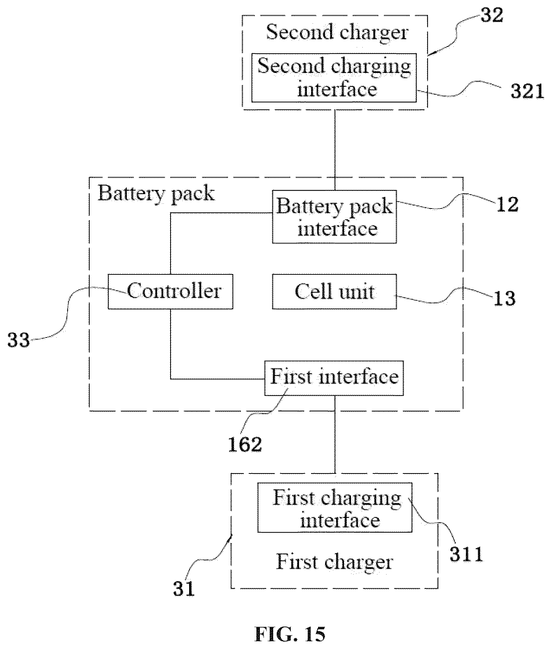

As shown in FIGS. 14 and 15, the charging combination 300 may further include a controller 33. In this example, the controller 33 is disposed in the battery pack 100. The controller 33 is configured to prevent the battery pack interface 12 from access to power when the first charger 31 is connected to the battery pack 100. That is to say, when the first charger 31 is charging the battery pack 100, the second charger 32 is prevented from charging the battery pack 100.

In other examples, the controller 33 may be further configured to prevent the first interface 162 from access to power when the second charger 32 is connected to the battery pack 100. That is to say, when the second charger 32 is charging the battery pack 100, the first charger 31 is prevented from charging the battery pack 100.

In some other examples, the charging combination 300 may include only the battery pack 100 and the first charger 31, that is to say, the battery pack 100 can only be charged by the first charger 31.

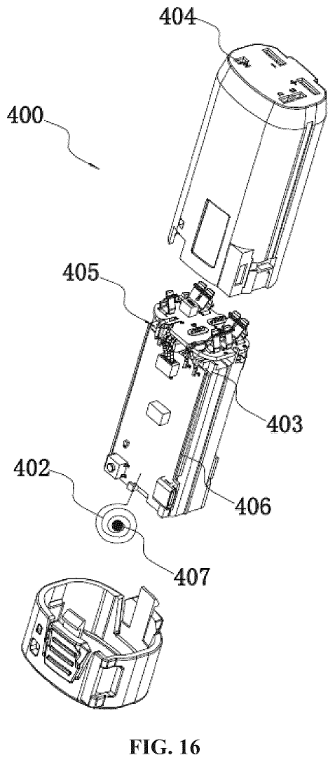

Another battery pack 400 is shown in FIG. 16. The battery pack 400 is basically the same as the battery pack 100 shown in FIG. 5 except that a wireless charging device 401 is further provided. Other structures of the battery pack 100 in FIG. 5, which are compatible with this example, can all be applied to this example, and the details are not repeated here. Differences between this example and the example shown in FIG. 5 are mainly described below.

As shown in FIGS. 16 to 19, the wireless charging device 401 is used for access to power to charge cell units 403 and includes a receiving coil 402. The receiving coil 402 is disposed at an end of multiple cell units 403 stacked facing away from a battery pack interface 404, that is, the receiving coil 402 is disposed at a second end of a first group of cells 405. The receiving coil 402 is electrically connected to a power management board 406.

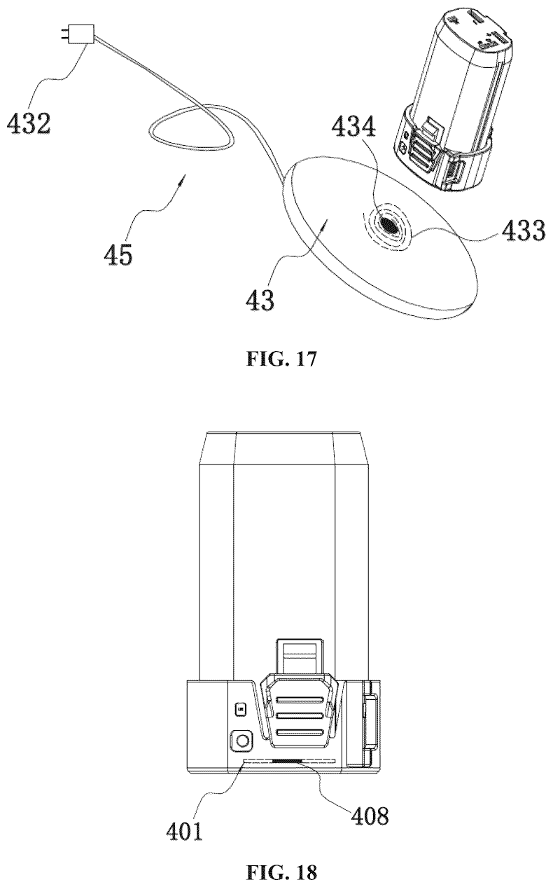

As shown in FIG. 17, another charging combination 45 is constituted by the battery pack 400 and a wireless charging apparatus 43. The wireless charging device 401 is connected to the power management board 406. The wireless charging device 401 mates with the wireless charging apparatus 43 so that the wireless charging apparatus 43 charges the cell units 403.

The wireless charging apparatus 43 includes a power output module and a power interface 432. The power output module is configured to mate with the wireless charging device 401. Specifically, the power output module includes a transmitting coil 433, the transmitting coil 433 matches the receiving coil 402, and the transmitting coil 433 and the receiving coil 402 can implement energy transfer. The power interface 432 is used for connecting an external power device. For example, the power interface 432 can be connected to a mains power grid. The maximum charging power of the wireless charging device 401 is less than or equal to 15 W. In this manner, the battery pack 400 in this example can be charged by conventional wireless charging apparatuses 43 on the market. For example, some wireless charging apparatuses 43 for charging mobile phones may be used for charging the battery pack 400 in this example. Thus, when a user purchases the battery pack 400 in this example, the user does not need to purchase the wireless charging apparatus 43 separately and can charge the battery pack 400 with a wireless charging apparatus 43 already available at home, thereby reducing the use cost of the user.

The transmitting coil and the receiving coil can be designed into various shapes according to the space in the battery pack housing, for example, they can be circular, elliptical, rectangular, etc. Alternatively, in this example, the battery pack housing is roughly elliptical, and correspondingly, the transmitting coil and the receiving coil can also be set to be elliptical, so that the space in the battery pack housing can be better utilized.

In some examples, the maximum charging power of the wireless charging device 401 is greater than or equal to 15 W. In this manner, the battery pack 400 can be fully charged quickly. The user may purchase a dedicated wireless charging apparatus 43 for charging, and the charging power of the wireless charging apparatus 43 for the battery pack 400 is greater than or equal to 20 W.

As for a battery pack 400 in another example, the battery pack 400 is basically the same as the battery pack 400 shown in FIG. 16 except that the cell unit 403 is a cylindrical cell. Thus, the wireless charging device 401 can mate with the wireless charging apparatus 43 to charge the cylindrical cell.

As shown in FIGS. 17 and 18, the battery pack 400 includes a positioning structure 407 that enables the battery pack 400 to be positioned at a charging position of the wireless charging apparatus 43. In this example, the positioning structure 407 may be a first magnetic device 408, and the corresponding wireless charging apparatus 43 is provided with a corresponding second magnetic device 434 at the charging position. The first magnetic device 408 mates with the second magnetic device 434 so that the battery pack 400 can be attracted at the charging position, making it convenient for the user to accurately position the battery pack 400 and ensuring the stability of charging.

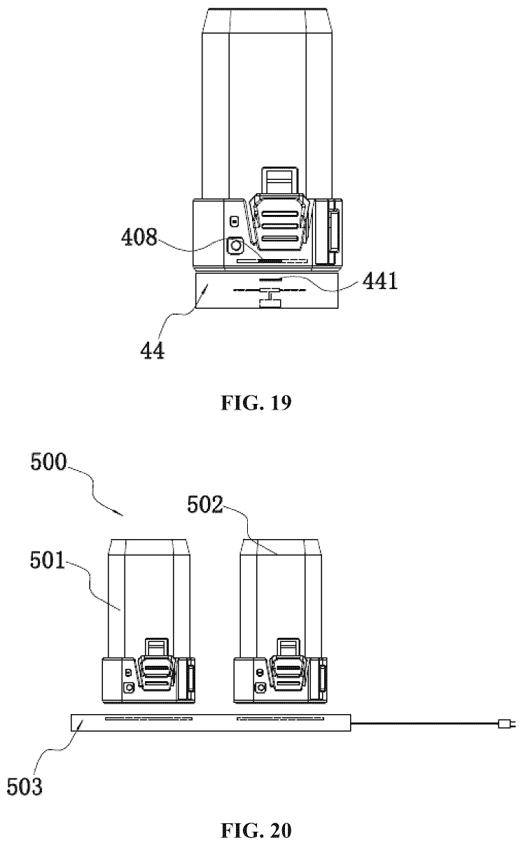

As shown in FIG. 19, an external fan 44 may also be attracted by the first magnetic device 408. The external fan 44 can mate with an air duct structure of the battery pack 400 to dissipate heat for the battery pack 400. The external fan 44 is provided with a third magnetic device 441 mating with the first magnetic device 408.

In some examples, the positioning structure may be a snap-fit structure, and the battery pack is positioned at the charging position of the wireless charging apparatus through the snap-fit structure.

In some examples, the positioning structure may be a particular positioning protrusion or groove on a surface of the battery pack. The corresponding wireless charging apparatus is provided with a corresponding positioning groove or protrusion. The protrusion mates with the groove so that the battery pack is positioned at the charging position.

In some examples, the positioning structure may be an outer shape formed on the surface of the battery pack, and the wireless charging apparatus is formed with a corresponding matching outer shape that can mate with the outer shape to position the battery pack at the charging position.

As shown in FIG. 20, another charging combination 500 includes a first battery pack 501, a second battery pack 502, and a wireless charging apparatus 503. The first battery pack 501 may be the same as the battery pack in FIG. 16 and includes a first cell unit and a first wireless charging device capable of charging the first cell unit. The first cell unit is a pouch cell, and the specific structure is not repeated. The second battery pack 502 may also be the same as the battery pack in FIG. 16 and includes a second cell unit and a second wireless charging device capable of charging the second cell unit. The second cell unit is the pouch cell, and the specific structure is not repeated. The wireless charging apparatus 503 is configured to charge the first battery pack 501 and the second battery pack 502 in a preset order. In this manner, the first battery pack 501 can be fully charged first and then the second battery pack 502 is charged, making it convenient for the user to use the first battery pack 501 in time.

In some examples, the wireless charging apparatus 503 may charge the first battery pack 501 and the second battery pack 502 simultaneously. In this manner, during operation of a tool body that requires two battery packs, the first battery pack 501 and the second battery pack 502 can be used in time. Alternatively, when two tool bodies need to work, the first battery pack 501 and the second battery pack 502 can be used in time respectively.

In some examples, the wireless charging apparatus 503 may first charge a battery pack with the lower power between the first battery pack 501 and the second battery pack 502. When the battery pack with the lower power is charged to have the same power as the other battery pack, the first battery pack 501 and the second battery pack 502 may be charged simultaneously.

In this example, the first cell unit and the second cell unit are each the pouch cell. In other examples, the first cell unit may be the pouch cell, while the second cell unit may be a cylindrical cell. Alternatively, in other examples, the first cell unit and the second cell unit may each be the cylindrical cell.

In this example, the wireless charging apparatus 503 may charge the first battery pack 501 and the second battery pack 502. It is to be understood that in other examples, the wireless charging apparatus 503 may charge more battery packs.

In this example, the wireless charging apparatus 503 has a first charging position for charging the first battery pack 501 and a second charging position for charging the second battery pack 502. It is to be understood that in other examples, the wireless charging apparatus 503 has multiple charging positions, and the multiple charging positions allow the first battery pack 501 and the second battery pack 502 to be charged at any positions in a charging region of the wireless charging apparatus 503 instead of being charged at particular positions, thereby improving the convenience of charging.

A power tool in another example includes a tool body, a first battery pack, and a second battery pack. The tool body includes an output piece, an electric motor, a first tool interface, and a second tool interface. The output piece is used for outputting power, and the electric motor is used for driving the output piece to move. The first tool interface is used for detachably connecting the first battery pack, and the second tool interface is used for detachably connecting the second battery pack. The first battery pack may be the battery pack in FIG. 5 or FIG. 16, and the specific structure is not repeated. The second battery pack may be the battery pack in FIG. 5 or FIG. 16, and the specific structure is not repeated. In this example, the first battery pack includes a first battery pack housing and a first cell unit, and the first cell unit is disposed in the first battery pack housing. The second battery pack includes a second battery pack housing and a second cell unit in the second battery pack housing. The first cell unit is a pouch cell and the second cell unit is the pouch cell. In this manner, the first battery pack and the second battery pack can each have a relatively high volumetric energy density, thereby extending the battery life of the power tool.

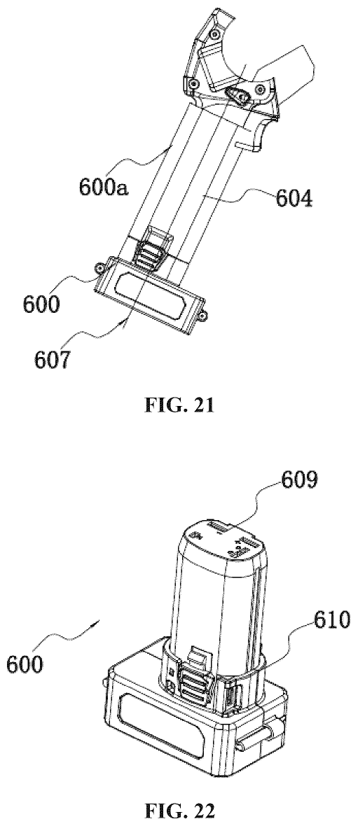

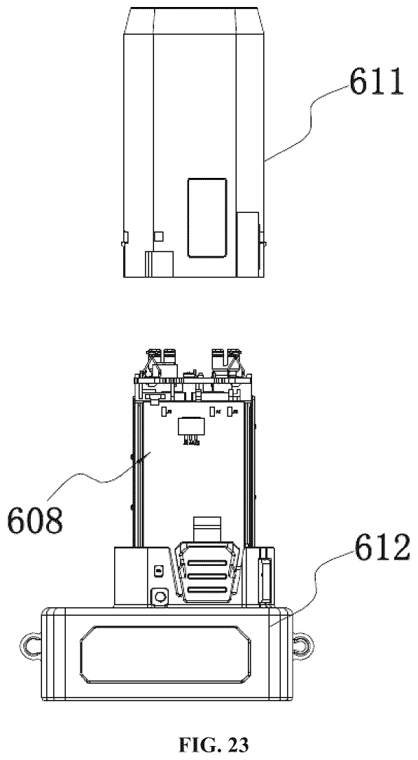

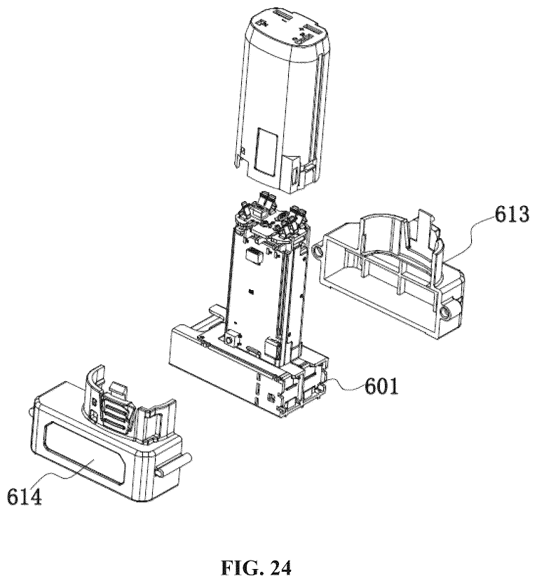

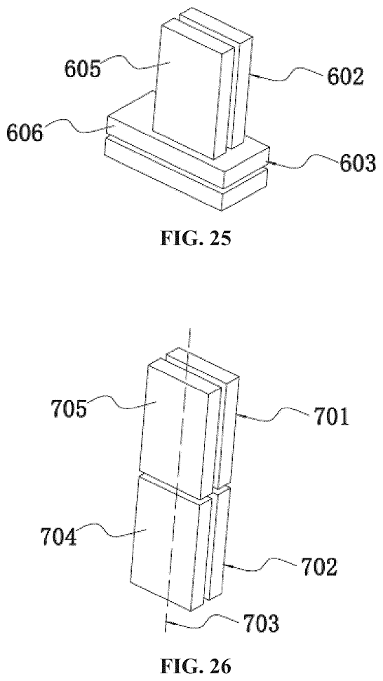

As shown in FIGS. 21 and 25, the present application further provides another battery pack 600 applicable to a tool body 600a. The battery pack 600 and the battery pack 100 in FIG. 5 can be adapted to the same tool body 21 and are mainly different in that the battery pack 600 includes a different number of cell units 601. For example, in the battery pack 100 shown in FIG. 5, the number of cell units 601 is 2, and two cell units 601 are connected in series so that the two cell units 601 constitute a first group of cells 602, which is also referred to as a 1P cell group. The number of cell units 601 included in the battery pack 600 in this example is 4. Four cell units 601 constitute a 2P cell group. Here, the two cell units 601 that are the same as the cell units 601 in FIG. 5 may be defined as the first group of cells 602, and the other two cell units 601 are defined as a second group of cells 603. In this example, the two cell units 601 in the first group of cells 602 are connected in series, the two cell units 601 in the second group of cells 603 are connected in series, and the first group of cells 602 and the second group of cells 603 are connected in parallel so that the four cell units 601 constitute the 2P cell group. Alternatively, in some examples, the two cell units 601 in the first group of cells 602 are connected in parallel, the two cell units 601 in the second group of cells 603 are connected in parallel, and the first group of cells 602 and the second group of cells 603 are connected in series so that the four cell units 601 may also be considered to constitute the 2P cell group.

In this example, when the battery pack 600 is coupled to the tool body 600a, the first group of cells 602 is at least partially disposed in a grip 604, and the second group of cells 603 is located outside the grip 604.

For convenience of description, in this example, the cell unit 601 in the first group of cells 602 may be defined as a first cell unit 605, and the cell unit 601 in the second group of cells 603 may be defined as a second cell unit 606. The first cell unit 605 and the second cell unit 606 are each a pouch cell. The first cell unit 605 is partially or entirely located in the grip 604, and the second cell unit 606 is located outside the grip 604. An extension plane of the first cell unit 605 is parallel to a first straight line 607. An extension plane of the second cell unit 606 is perpendicular to the first straight line 607. The extension plane of the second cell unit 606 is perpendicular to the extension plane of the first cell unit 605. A circuit board assembly 608 and the first group of cells 602 are arranged in the same manner as those of the battery pack 100 in FIG. 5. A main difference is that the second group of cells 603 is perpendicularly disposed at a first end of the first group of cells 602 facing away from a battery pack interface 609.

A battery pack housing 610 includes a first housing portion 611 and a second housing portion 612, where the first housing portion 611 is the same as that of the battery pack 100 in FIG. 3, and the first housing portion 611 and the second housing portion 612 are detachably connected to each other. The second housing portion 612 includes a left housing portion 613 and a right housing portion 614, and the left housing portion 613 and the right housing portion 614 are engaged to form an accommodation space for accommodating the second group of cells 603. The battery pack housing 610 is basically T-shaped so that the volume of the battery pack 600 can be reduced when the capacity of the battery pack 600 is increased. Alternatively, in some examples, the battery pack housing 610 may basically be L-shaped.

As shown in FIG. 26, it is to be understood that in some examples, a first group of cells 701 and a second group of cells 702 may be arranged along a direction of a first straight line 703, that is, second cell units 704 are disposed below first cell units 705.

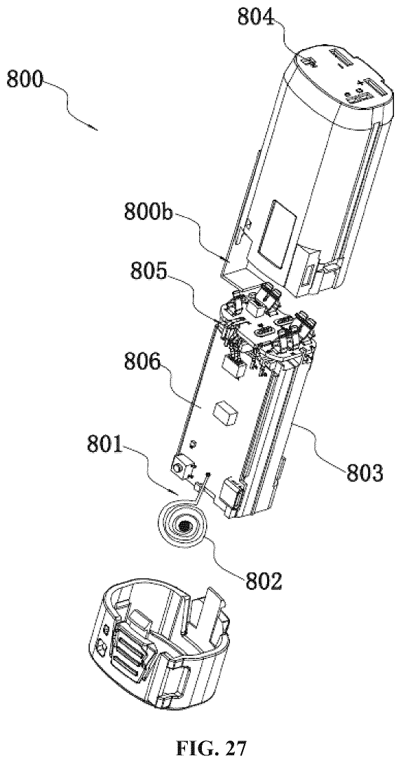

As shown in FIG. 27, another battery pack 800 is basically the same as the battery pack 100 shown in FIG. 5, except that a wireless discharge device 801 is provided. The other structures of the battery pack 100 in FIG. 5 that are compatible with the present example can be applied to the present example, and the same parts will not be described in detail. The following mainly introduces the differences between the present example and the example shown in FIG. 5.

As shown in FIG. 27, the wireless discharge device 801 is used for discharge, and includes a transmitting coil 802, which is arranged at one end of stacked multiple cell units 803 away from a battery pack interface 804, that is, the transmitting coil 802 is arranged at a second end of a first group of cells 805. The transmitting coil 802 is electrically connected to a power management board 806.

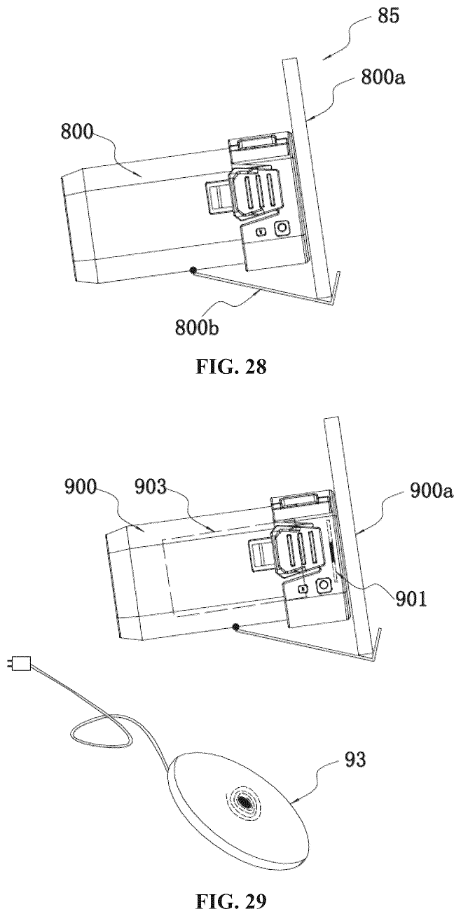

As shown in FIG. 28, a discharge combination 85 is formed by the battery pack 800 and an electrical apparatus 800a. At this time, the battery pack 800 can be used as a charger for charging the electrical apparatus 800a, or as a power supply for the electrical apparatus 800a. The wireless discharge device 801 is connected to the power management board 806, and the wireless discharge device 801 cooperates with the electrical apparatus 800a so that the battery pack 800 charges or supplies power to the electrical apparatus 800a. The electrical apparatus 800a can be, for example, a mobile phone, and the mobile phone can be charged by the battery pack 800 in a wireless charging manner. Alternatively, the electrical apparatus can also be a lighting lamp, and the battery pack can supply power to the lighting lamp in a wireless power supply manner, so that when the user is outdoors without an AC power supply, the battery pack can be used to power the lighting lamp in a timely manner.

The electrical apparatus 800a includes a power receiving module. The power receiving module is used to cooperate with the wireless discharge device 801. Specifically, the power receiving module includes a receiving coil, which matches the transmitting coil 802, and the receiving coil and the transmitting coil 802 can realize energy transfer. In this way, the battery pack 800 of this example can charge common mobile phones, watches and other daily electrical apparatuses on the market. For users, the battery pack 800 that can power the power tools can also charge or power mobile phones and other apparatuses through a wireless charging manner, which brings convenience to the user's work and life and saves costs.

The maximum discharge power of the wireless discharge device 801 is less than or equal to 15 W. In this way, the battery pack 800 of this example can charge most of the electrical apparatuses on the market that can be charged by the wireless charging manner.

In some examples, the maximum discharge power of the wireless discharge device is greater than 15 W. In this way, the battery pack can quickly charge the electrical apparatus and increase the charging speed.

As shown in FIG. 28, the battery pack 800 includes a bracket 800b. The bracket 800b can be used to support the electrical apparatus 800a, so that the electrical apparatus 800a can better contact the battery pack 800 or better make the power receiving module of the electrical apparatus 800a and the wireless discharge device 801 of the battery pack 800a correspond to each other in position. The bracket 800b has a storage state shown in FIG. 27 and a working state shown in FIG. 28.

As shown in FIG. 29, another battery pack 900 is basically the same as the battery pack 800 shown in FIG. 27, and the main difference is that it has a wireless charging and discharging device 901. The other structures of the battery pack 800 in FIG. 27 that are compatible with this example can be applied to this example, and the same parts will not be described in detail. The following mainly introduces the differences between this example and the example shown in FIG. 27. Simply put, in this example, the wireless discharge device 801 of the battery pack 800 shown in FIG. 27 is changed to the wireless charging and discharging device 901 of this example to form the battery pack 900 of this example.

The wireless charging and discharging device 901 can not only charge the battery pack 900 through a wireless charging apparatus 93, but also enable the battery pack 900 to charge or supply power to an electrical apparatus 900a. The wireless charging and discharging device 901 can have a charging mode and a discharging mode. When the battery pack 900 needs to be charged, the wireless charging and discharging device 901 can switch to the charging mode, and the battery pack 900 can be charged by the wireless charging apparatus 93. When the wireless charging and discharging device 901 switches to the discharging mode, the electrical apparatus 900a can be charged by the battery pack 900.

It should be noted that the cell unit 403 in FIG. 16, the cell unit 803 in FIG. 27, and the cell unit 903 included in FIG. 39 all have the same structure, size, arrangement, function, performance, parameters, etc. as the cell unit 103 in the example shown in FIG. 1 to FIG. 15, and are all pouch cells, which will not be described in detail.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
a tool body comprising an output piece for outputting power, an electric motor for driving the output piece to move, a body housing for accommodating at least part of the electric motor, and a body interface; and
a battery pack detachably connectable to the body housing to supply power to the electric motor, the battery pack comprising a battery pack interface for mating and connecting with the body interface when the battery pack is mounted to the tool body, a battery pack housing, and a cell unit disposed in the battery pack housing and electrically connected to the battery pack interface, wherein the cell unit is a pouch cell and the battery pack has a volumetric energy density greater than or equal to 100 mWh/cm³ and a nominal voltage less than or equal to 9 V.

2. The power tool according to claim 1, wherein the battery pack has a volumetric energy density greater than or equal to 120 mWh/cm³.

3. The power tool according to claim 1, wherein the battery pack has a gravimetric energy density greater than or equal to 100 mWh/g.

4. The power tool according to claim 1, wherein the battery pack has a nominal voltage of 8 V.

5. The power tool according to claim 1, wherein two cell units are disposed in the battery pack housing, and the battery pack has a weight less than or equal to 200 g.

6. The power tool according to claim 1, wherein the battery pack has a capacity greater than or equal to 1.5 Ah and less than or equal to 5 Ah.

7. The power tool according to claim 1, wherein four cell units are disposed in the battery pack housing, and the four cell units constitute a 2P cell group.

8. The power tool according to claim 1, wherein the body housing comprises an electric motor accommodation portion for accommodating the electric motor and a grip for a user to hold, and when the battery pack is coupled to the tool body, at least part of the cell unit is located in the grip.

9. A battery pack applicable to a power tool, comprising:
a battery pack housing formed with a coupling portion for connecting to the power tool;
a cell unit disposed in the battery pack housing; and
a battery pack interface used for outputting power to the power tool and electrically connected to the cell unit, wherein the cell unit is a pouch cell and the battery pack has a volumetric energy density greater than or equal to 100 mWh/cm³ and a nominal voltage less than or equal to 9 V.

10. A battery pack applicable to a power tool having a body interface, comprising:
a battery pack housing comprising a battery pack interface connectable to the body interface of the power tool when the battery pack is mounted to the power tool; and
a cell unit disposed in the battery pack housing and electrically connected to the battery pack interface, wherein the cell unit is a pouch cell and the battery pack has a gravimetric energy density greater than or equal to 100 mWh/g and a nominal voltage less than or equal to 9 V.

11. A power tool, comprising:
a tool body comprising an output piece for outputting power, an electric motor for driving the output piece to move, a body housing for accommodating at least part of the electric motor, and a body interface; and
a battery pack detachably connectable to the body housing to supply power to the electric motor, the battery pack comprising a battery pack interface for mating and connecting with the body interface when the battery pack is mounted to the tool body, a battery pack housing, and a cell unit disposed in the battery pack housing and electrically connected to the battery pack interface, wherein the cell unit is a pouch cell, a ratio of output power of the battery pack to a volume of the battery pack is greater than or equal to 1 W/cm³, and the volume of the battery pack is less than or equal to 150 cm³.

12. The power tool according to claim 11, wherein two cell units are disposed in the battery pack housing, and the two cell units are connected in series.

13. The power tool according to claim 11, wherein the output power of the battery pack is greater than or equal to 140 W and less than or equal to 750 W.

14. The power tool according to claim 11, wherein the battery pack has a gravimetric energy density greater than or equal to 100 mWh/g.

15. The power tool according to claim 11, wherein two cell units are disposed in the battery pack housing, and the battery pack has a weight less than or equal to 180 g.

16. The power tool according to claim 11, wherein the battery pack has a capacity greater than or equal to 1.5 Ah and less than or equal to 5 Ah.

17. The power tool according to claim 11, wherein the power tool is a handheld power tool, the body housing comprises a grip for a user to hold, and the battery pack is coupled to the grip.

18. The power tool according to claim 11, wherein the body housing comprises an electric motor housing portion for accommodating at least part of the electric motor and a grip for a user to hold, when the battery pack is coupled to the tool body, at least part of the cell unit is located in the grip, the battery pack is coupled to the grip along a direction of a first straight line, a perimeter of an outer contour of a cross-section of a portion of the battery pack in the grip in a plane perpendicular to the first straight line is greater than or equal to 10 cm and less than or equal to 14 cm, and the ratio of the output power of the battery pack to the volume of the battery pack is greater than or equal to 1 W/cm³.

19. The power tool according to claim 18, wherein an extension plane of the pouch cell is basically parallel to the first straight line.

20. The power tool according to claim 11, wherein the body housing comprises an electric motor housing portion for accommodating at least part of the electric motor and a grip for a user to hold, the cell unit is the pouch cell, when the battery pack is coupled to the tool body, at least part of the cell unit is located in the grip, the battery pack is coupled to the grip along a direction of a first straight line, an area of a cross-section of a portion of the battery pack in the grip in a plane perpendicular to the first straight line is greater than or equal to 8 cm² and less than or equal to 14 cm², and the ratio of the output power of the battery pack to the volume of the battery pack is greater than or equal to 1 W/cm³.
